(19) United States
(12) Patent Application Publication
(10) Pub. No.: US 2017/0003525 A1
(43) Pub. Date: Jan. 5, 2017

(54) LIGHT CONTROLLING SHEET AND LIGHT CONTROLLING PLATE

(71) Applicant: DAI NIPPON PRINTING CO., LTD., Tokyo-to (JP)

(72) Inventors: Masahiro Tatsuzawa, Tokyo-to (JP); Takahiro Yagi, Tokyo-to (JP); Keiichi Murakami, Tokyo-to (JP); Yuki Kumagai, Tokyo-to (JP)

(21) Appl. No.: 15/113,689

(22) PCT Filed: Jan. 23, 2015
(86) PCT No.: PCT/JP2015/051917

§ 371 Date: Jul. 22, 2016

(30) Foreign Application Priority Data
Jan. 24, 2014 (JP) 2014-011883

(51) Int. Cl. G02F 1/1333; G02F 1/1337; G02F 1/13363; G02B 5/30

(52) U.S. Cl. CPC G02F 1/1333; G02B 5/3016; G02F 1/1337; G02F 1/13363; G02F 2001/133631; G02F 2001/133337

(57) ABSTRACT

A main object is to provide a light controlling sheet and a light controlling plate each excellent in weatherability and endurance. An embodiment of the invention is a light controlling sheet including the following: a light controlling layer in which two or more regions for changing a polarization state or phase state of transmitted light are each formed into a constant shape at a constant interval; an adhesive layer formed on the light controlling layer; a migration preventing layer formed on the adhesive layer; and a weatherable adhesive layer including a weatherable agent formed on the migration preventing layer.

### TECHNICAL FIELD

The present disclosure relates to a light controlling sheet and a light controlling plate each having a light controlling function.

### BACKGROUND ART

Light controlling plates, whose light transmittance can be changed by applying an external power such as voltage thereto, thereby controlling incident light quantity, are conventionally known.

Such a light controlling plate is, for example, a light controlling plate including a light controlling sheet on a surface of a transparent substrate, the light controlling sheet being produced by sandwiching, between transparent conductive bases, a light controlling layer in which a light controlling suspension is dispersed in a resin matrix, this suspension being a suspension in which alignment particles responsive to voltage are dispersed (see Patent Document 1). This light controlling plate is a plate in which a voltage is applied to the light controlling sheet to adjust the transmitted light quantity in accordance with a response of the alignment particles to the voltage, thereby attaining display switching.

In detail, when a voltage is applied to the light controlling sheet, the alignment particles in the light controlling layer are aligned so that incident light can be transmitted through the light controlling sheet. Thus, the light controlling plate turns into a transparent state that the outside is clearly visible (hereinafter referred to as a bright state).

In the meantime, in a state that no voltage is applied to the light controlling sheet, the alignment particles are not aligned so that incident light thereto is absorbed, scattered or reflected by Brownian motion of the alignment particles. Thus, the light cannot be transmitted through the light controlling sheet so that the light controlling plate turns into a state that the outside is invisible due to the light-shielding (hereinafter referred to as a dark state).

However, the light controlling sheet requires a long period of time for shifting the alignment particles into an alignment state by applying a voltage to the sheet or for shifting the alignment particles into a non-alignment state by stopping the voltage application. Thus, there remains a problem that it is difficult to switch the light controlling plate between the dark state and the bright state instantaneously.

It is also necessary for the voltage application that an electrode layer including, for example, interconnections is used together. Furthermore, an electric power for the voltage application is also necessary. Accordingly, costs are high for setting and using the light controlling plate, so that the light controlling plate is not easily used.

For this problem, a development of a light controlling plate, which can be adjusted in incident light quantity easily without requiring the application of any voltage, is being promoted.

For example, Patent Document 2 discloses a light controlling glass in which two light controlling parts each including a polarizing plate and a pattern retardation layer are arranged on a transparent substrate so that the respective pattern retardation layers of the light controlling parts face each other, each of these pattern retardation layers being a layer in which plural retardation regions different from each other in at least one of in-plane slow axis and retardation are each formed into the form of a stripe at a constant interval. In this case, each of the light controlling layers denotes a layered body including a combination of the polarizing plate with the pattern retardation layer.

In this light controlling glass, one of the two light controlling parts is slid to be shifted to change a pattern-correspondence relationship between the retardation regions in the both pattern retardation layers, thereby attaining display switching. Hereinafter, a light controlling glass using such a sliding mechanism may be referred to as a “sliding-type light controlling glass”.

FIGS. 6A to 6B are explanatory views for describing a light controlling function of a sliding-type light controlling glass. In FIGS. 6A to 6B, each of pattern retardation layers 40A and 40B is a layer including a pattern in which first retardation regions O1 and O1′ and second retardation regions O2 and O2′ are alternately formed into the form of stripes. The in-plane slow axes “a” of the first retardation regions O1 and O1′ are orthogonal to those of the second retardation regions O2 and O2′. The in-plane retardation of the first retardation regions O1 and O1′ and the second retardation regions O2 and O2′ is λ/4. Furthermore, the polarization axes of two polarizing plates 50A and 50B have an orthogonal relationship. Incidentally, illustration of the glass is omitted.

As illustrated in FIG. 6A, when light penetrates from the light controlling part 60A to the light controlling part 60B, the polarizing plate 50A transmits, among incident light L1, only a linearly polarized light L2 vibrating in a direction equal to a polarization axis direction Y of the polarizing plate 50A. In the first retardation regions O1 and the second retardation regions O2 of the pattern retardation layer 40A, the linearly polarized light L2 is rotated in directions reverse to each other, by a retardation of λ/4, to be converted to a circularly polarized light L3. The circularly polarized light L3 enters into a light controlling part 60B to be further rotated in directions reverse to each other, by a retardation of λ/4 in the first retardation regions O1′ and the second retardation regions O2′ of the pattern retardation layer 40B, thereby being converted to a linearly polarized light L4.

At this time, for the pattern retardation layers 40A and 40B, for example, the first retardation regions O1 and O1′ having a correspondence relationship to each other have the same in-plane slow-axis direction, that is, the same alignment direction; thus, the rotating direction of the linearly polarized light in these regions will be the same. In other words, vibration direction of the linearly polarized light L4 is that of the linearly polarized light L2 rotated by 90°.

Accordingly, the vibration direction of the linearly polarized light L4 is identical with the polarization axis direction X of the polarizing plate 50B. Consequently, the polarized light L4 can be transmitted through the polarizing plate 50B so that the sliding-type light controlling glass 100 will be in a bright state by the coming out light L5.

In the meantime, FIG. 6B illustrates an example in which the light controlling part 60B in FIG. 6A is slid and shifted in a direction orthogonal to the pattern of the retardation regions. In this case, in the pattern retardation layers 40A and 40B, for example, for the first retardation regions O1 and the second retardation regions O2′ having a correspondence relationship between each other, in-plane slow-axis directions thereof have orthogonal relationship to each other so that the rotating directions of straightly polarized light in the regions are opposite to each other. In other words, circularly polarized light rotated by a retardation of λ/4 in the first retardation regions O1 is rotated into a reverse direction by λ/4 in the second retardation regions O2′. Consequently, vibration direction of a straightly polarized light L4 is equal to vibration direction of a straightly polarized light L2.

For this reason, the vibration direction of the straightly polarized light L4 will be orthogonal to the polarization axis direction X of the polarizing plate 50B, so that the straightly polarized light L4 cannot be transmitted through the polarizing plate 50B. Consequently, the sliding-type light controlling glass 100 will be in a dark state.

### CITATION LIST

### Patent Documents

Patent Document 1: JP 2013-210670 A
Patent Document 2: WO 2012/092443
Patent Document 3: Japanese Patent No. 4881208

### SUMMARY

### Technical Problem

Incidentally, a light controlling plate is usually used for adjusting insolation, for securing privacy, etc. for example as a member from which light incident upon, such as a window glass. However, in the above-mentioned sliding-type light controlling glass, its light controlling layer absorbs ultraviolet rays and other rays contained in transmitted light to be easily photodegraded. Consequently, there arises a problem that the light controlling function is diminished with the passage of time. Moreover, the addition of a weatherable agent, such as an ultraviolet absorbent, to the light controlling layer causes a problem that the light controlling layer is changed in color. Reasons therefor are not necessarily clear; however, the weatherable agent would react with some other material that constitutes the light controlling layer to cause the color change.

For the above-mentioned problem, the present inventors have been investigating the following: in a light controlling sheet including a light controlling layer and an adhesive layer for bonding the light controlling layer to an adherend such as a glass, the adhesive layer is rendered a weatherable adhesive layer containing the weatherable agent without incorporating an ultraviolet absorber or any other weatherable agent into the light controlling layer, thereby improving in weatherability and endurance of the light controlling sheet as a whole.

This technique is based on an idea that: the light controlling layer does not contain any ultraviolet absorbent or any other weatherable agent to be prevented from undergoing its color change due to the incorporation of a weatherable agent; and further, prior to the light incidence into the light controlling sheet, since ultraviolet rays or other wavelength light which deteriorate the light controlling layer is absorbed by weatherable agent in the weatherable adhesive layer, the photodegradation of the light controlling layer can be prevented. Additionally, the weatherable adhesive layer itself can also be improved in weatherability since the weatherable adhesive layer contains the weatherable agent. It is therefore assumed to lead to improvements of the light controlling sheet as a whole in weatherability and endurance.

Incidentally, Patent Document 3 discloses that: as an adhesive used when a film having light transmissivity is bonded to, for example, a window glass, a weatherable adhesive containing a (meth)acrylate based copolymer including carboxyl groups, a metal chelate type crosslinking agent, and a triazine type ultraviolet absorbent is used; and the use of the weatherable adhesive restrains a photodegradation of the bonded film through ultraviolet absorbing ability of the adhesive.

However, the following problem remains: even when the above-mentioned weatherable agent is contained in a weatherable adhesive layer positioned nearer to a light-incidence side than a light controlling layer, the light controlling sheet as a whole cannot be sufficiently improved in weatherability or endurance.

In light of the above-mentioned actual situation, the present disclosure has been made, and a main object thereof is to provide a light controlling sheet and a light controlling plate which are excellent in weatherability and endurance.

### Solution to Problem

In order to solve the above-mentioned problems, the present inventors have made eager investigations to presume that a deterioration and a color change of a light controlling sheet are caused by the so-called migration, that is, a phenomenon that in the light controlling sheet, a weatherable agent contained in its weatherable adhesive layer oozes out into a different layer adjacent to the weatherable adhesive layer; and further to find out that by preventing the migration of the weatherable agent, the light controlling sheet as a whole can be improved in weatherability and endurance. In this way, the present disclosure has been achieved.

That is, an embodiment of the present invention provides a light controlling sheet comprising: a light controlling layer in which two or more regions for changing a polarization state or phase state of transmitted light are each formed into a constant shape at a constant interval; an adhesive layer formed on the light controlling layer; a migration preventing layer formed on the adhesive layer; and a weatherable adhesive layer including a weatherable agent formed on the migration preventing layer.

An embodiment of the present invention makes it possible to restrain the migration of the weatherable agent contained in the weatherable adhesive layer by arranging the migration preventing layer between the weatherable adhesive layer and the light controlling layer, thereby the weatherable adhesive layer can be prevented from being yellowed and being deteriorated in adhesive strength due to a photodegradation. Moreover, light enters into the weatherable adhesive layer prior to the light controlling layer, so that the weatherable agent contained in the weatherable adhesive layer absorbs ultraviolet rays, and other wavelength light that deteriorate the light controlling layer. Accordingly, the light controlling layer can be restrained from being deteriorated. Furthermore, since the light controlling sheet includes the migration preventing layer, color change due to reaction between the weatherable agent and materials that constitute the light controlling layer can be prevented.

In an embodiment of the present invention, it is preferable that the migration preventing layer comprises a transparent resin. This is because the migration preventing layer comprising the transparent resin is inexpensive and widely usable.

In the case of this embodiment of the invention, the transparent resin is preferably a polyester resin. Furthermore, the polyester resin is preferably polyethylene terephthalate (hereinafter abbreviated to PET as the case may be). When the transparent resin is the polyester resin, in particular PET, the migration preventing layer can have a high crosslinkage density so that the migration of the weatherable agent can be efficiently hindered. Moreover, the migration preventing layer comprising PET is inexpensive and widely usable.

In the embodiment of the present invention, it is preferable that the migration preventing layer comprises a transparent inorganic compound. The layer or film comprising the transparent inorganic compound is high in density even when small in thickness. Thus, the migration of the weatherable agent can be efficiently hindered.

In the embodiment of the present invention, it is preferable that the weatherable agent is an ultraviolet absorbent. The weatherable adhesive layer and the light controlling layer are deteriorated mainly by ultraviolet rays contained in incident light. Thus, the use of the ultraviolet absorbent as the weatherable agent makes it possible to prevent the light controlling sheet more efficiently from being deteriorated.

In the embodiment of the present invention, it is preferable that: the light controlling layer comprises a pattern retardation layer, and a polarizing plate arranged nearer to the adhesive layer than to the pattern retardation layer; the pattern retardation layer comprises a transparent film substrate, an alignment layer formed on the transparent film substrate, and a retardation layer formed on the alignment layer; and the retardation layer is a layer in which two or more retardation regions different from each other in at least one of in-plane slow-axis direction and retardation are each formed into a constant shape at a constant interval. When the light controlling sheet of an embodiment of the present invention is used to produce a light controlling plate, such structure of the light controlling layer makes it possible to easily design the light controlling plate as a light controlling plate including a sliding mechanism, and further make the operation of the light controlling plate easy.

In the embodiment of the present invention, it is preferable that an adhesive strength of the weatherable adhesive layer is equal to or less than an adhesive strength of the adhesive layer. Since the weatherable adhesive layer becomes a bonding surface to an adherend such as a window glass, it is possible to peel the light controlling sheet easily from the adherend without causing a material breakage of the light controlling sheet at the adhesive layer.

Further, an embodiment of the present invention provides a light controlling plate comprising: a first light controlling part including a first light controlling sheet; and a second light controlling part including a second light controlling sheet, and the first light controlling part and the second light controlling part being arranged so that the first light controlling sheet and the second light controlling sheet face each other at an interval, the first light controlling sheet and the second light controlling sheet each comprises at least an adhesive layer and a light controlling layer formed on the adhesive layer; the light controlling layer is a layer in which two or more regions for changing a polarization state or phase state of transmitted light are each formed into a constant shape at a constant interval; at least one of the first light controlling sheet and the second light controlling sheet further comprises a migration preventing layer on the adhesive layer, at an opposite side to a side in which the light controlling layer is formed, and a weatherable adhesive layer including a weatherable agent formed on the migration preventing layer; and at least one of the first light controlling part and the second light controlling part is shiftable in a plane direction crossing the regions of the light controlling layer.

According to an embodiment of the present invention, the light controlling sheet in at least one of the first light controlling part and the second light controlling part includes the above-mentioned layer structure, in which the migration preventing layer is arranged between the weatherable adhesive layer and the light controlling layer. This layer structure makes it possible to restrain the migration of the weatherable agent contained in the weatherable adhesive layer, and to prevent the weatherable adhesive layer from being yellowed and being deteriorated in adhesive strength due to a photodegradation. Moreover, the light controlling parts, in which the light controlling sheet including the weatherable adhesive layer and the migration preventing layer are formed, is arranged on a light-incidence side, so that light enters into the weatherable adhesive layer prior to the light controlling layer. Consequently, the weatherable agent contained in the weatherable adhesive layer absorbs ultraviolet rays and other wavelength light which deteriorate the light controlling layer. Thus, the light controlling layer in each of the light controlling parts can be restrained from being photodegraded. Furthermore, by including the migration preventing layer, color change due to reaction between the weatherable agent and a material which constitutes the light controlling layer can be prevented. In this way, the light controlling plate having high endurance and weatherability can be obtained.

In the embodiment of the present invention, it is preferable that the migration preventing layer comprises a transparent resin. The migration preventing layer comprising the transparent resin is inexpensive and widely usable.

In this embodiment of the invention, the transparent resin is preferably a polyester resin. Furthermore, the polyester resin is preferably PET. When the transparent resin is the polyester resin, in particular PET, the migration preventing layer can have a high crosslinkage density so that the migration of the weatherable agent can be efficiently hindered. Moreover, the migration preventing layer comprising PET is inexpensive and widely usable.

In the embodiment of the present invention, the migration preventing layer is preferably a layer comprising a transparent inorganic compound. The layer or film comprising the transparent inorganic compound is high in density even when small in thickness. Thus, the migration of the weatherable agent can be efficiently hindered.

In the embodiment of the present invention, it is preferable that the weatherable agent is an ultraviolet absorbent. The weatherable adhesive layer and the light controlling layer are deteriorated mainly due to ultraviolet rays contained in incident light. Thus, the use of the ultraviolet absorbent as the weatherable agent makes it possible to prevent the first and second light controlling sheets efficiently from being deteriorated, so that the light controlling plate as a whole can be improved in endurance.

In the embodiment of the present invention, it is preferable that: the light controlling layer comprises a pattern retardation layer, and a polarizing plate arranged nearer to the adhesive layer than to the pattern retardation layer; the pattern retardation layer comprises a transparent film substrate, an alignment layer formed on the transparent film substrate, and a retardation layer formed on the alignment layer; and the retardation layer is a layer in which two or more retardation regions different from each other in at least one of in-plane slow-axis direction and retardation are each formed into a constant shape at a constant interval. By including the light controlling layer of such configuration, the light controlling plate of an embodiment of the invention can be easily designed as a light controlling plate including a sliding mechanism, and further make the operation of the light controlling plate easy.

In the embodiment of the present invention, it is preferable the first light controlling part is a part in which the first light controlling sheet is disposed on a surface of a first transparent substrate, and the second light controlling part is a part in which the second light controlling sheet is disposed on a surface of a second transparent substrate.

In the embodiment of the present invention, it is preferable that an adhesive strength of the weatherable adhesive layer is equal to or less than an adhesive strength of the adhesive layer. The weatherable adhesive layer becomes a bonding surface to an adherend such as a transparent substrate. Therefore, easy peeling at the adhesive layer without causing a material breakage of the light controlling sheet is possible.

### Advantageous Effects of Disclosure

In the light controlling sheet of embodiments of the present invention, a deterioration of the light controlling layer can be hindered by the weatherable agent contained in the weatherable adhesive layer. Moreover, the migration preventing layer restrains the migration of the weatherable agent into any layer adjacent thereto. Thus, the weatherable adhesive layer can be prevented from being deteriorated and the light controlling layer can be prevented from being changed in color due to reaction with the weatherable agent. Therefore, effects of high weatherability and endurance can be obtained.

### BRIEF DESCRIPTION OF THE DRAWINGS

FIGS. 1A to 1B are schematic plan view and sectional view illustrating an example of a light controlling sheet according to an embodiment of the present invention.

FIGS. 2A to 1B are schematic views illustrating light controlling function of a light controlling sheet according to an embodiment of the present invention.

FIGS. 3A to 3B are schematic plan views illustrating an example of a light controlling layer in an embodiment of the present invention.

FIGS. 4A to 4B are schematic sectional views illustrating another example of a light controlling sheet according to an embodiment of the present invention.

FIGS. 5A to 5B are schematic sectional view and top view illustrating an example of a light controlling plate according to an embodiment of the present invention.

FIGS. 6A to 6B are schematic views illustrating light controlling function of a sliding-type light controlling glass.

### DESCRIPTION OF EMBODIMENTS

Hereinafter, a light controlling sheet and a light controlling plate according to embodiments of the present invention will be described in detail.

A. Light Controlling Sheet

First, a light controlling sheet according to an embodiment of the present invention will be described. A light controlling sheet according to an embodiment of the present invention is a light controlling sheet comprising: a light controlling layer in which two or more regions for changing a polarization state or phase state of transmitted light are each formed into a constant shape at a constant interval; an adhesive layer formed on the light controlling layer; a migration preventing layer formed on the adhesive layer; and a weatherable adhesive layer including a weatherable agent formed on the migration preventing layer.

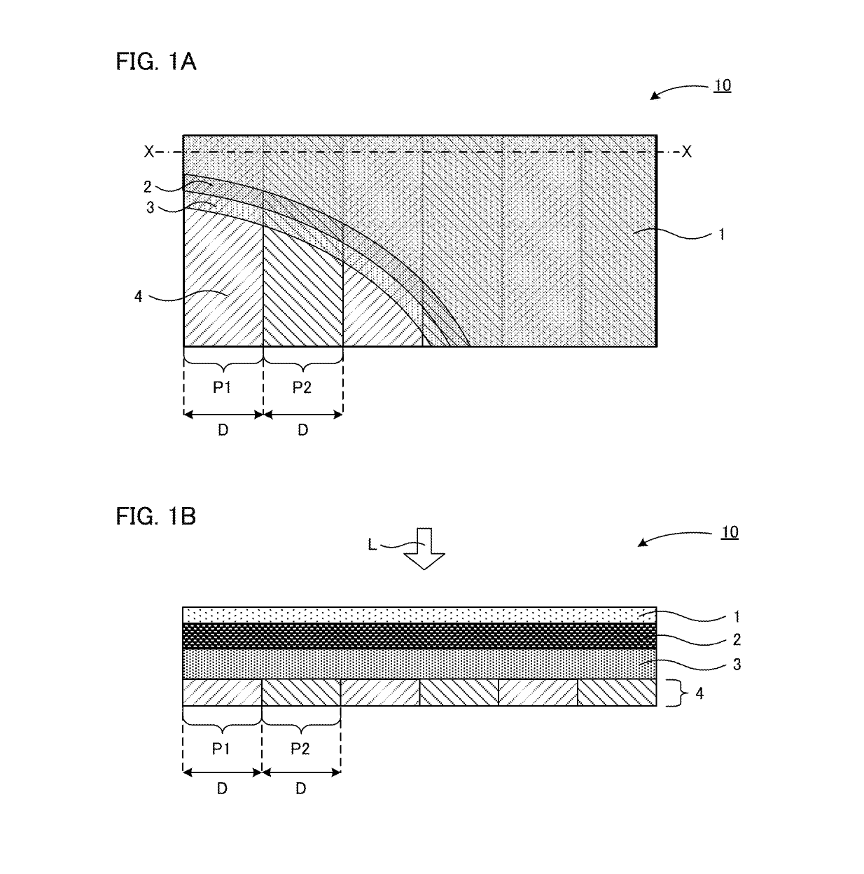

The light controlling sheet of an embodiment of the present invention will be described with reference to the drawings. FIG. 1A is a schematic plan view illustrating an example of the light controlling sheet of an embodiment of the invention. Therein, its weatherable adhesive layer, migration preventing layer, and adhesive layer are partially omitted for the description. FIG. 1B is an X-X line sectional view of FIG. 1A.

A light controlling sheet 10 of the example of an embodiment of the present invention is a sheet in which a weatherable adhesive layer 1 containing a weatherable agent, a migration preventing layer 2, an adhesive layer 3, and a light controlling layer 4 are laminated in this order. The weatherable adhesive layer 1 is arranged on the migration preventing layer 2 at an opposite side to a side in which the light controlling layer 4 is formed.

The light controlling layer 4 is a layer in which regions P1 and regions P2 for changing a polarization state or phase state of transmitted light are alternately formed to be each made into a constant shape (stripe shape) at a constant interval D. Specifically, each of a plurality of the regions P1 and P2 has a constant width D and a constant shape. A plurality of the regions P1 or the regions P2 are alternately arranged and continuously formed to contact each other without generating any gap. Any two adjacent regions P1 or two adjacent regions P2, have therebetween the constant interval D, which corresponds to the width D of the region P2 or region P1 positioned between the two regions.

Incidentally, hereinafter, in any light controlling sheet and any light controlling layer, each region formed into a constant shape at a constant interval may be referred to as a “pattern region”.

In the light controlling sheet 10 illustrated in FIGS. 1A to 1B, the migration preventing layer 2 is used so as to be arranged nearer to a light-L-incidence side than the light controlling layer 4, so that advantageous effects of an embodiment of the present invention can be obtained.

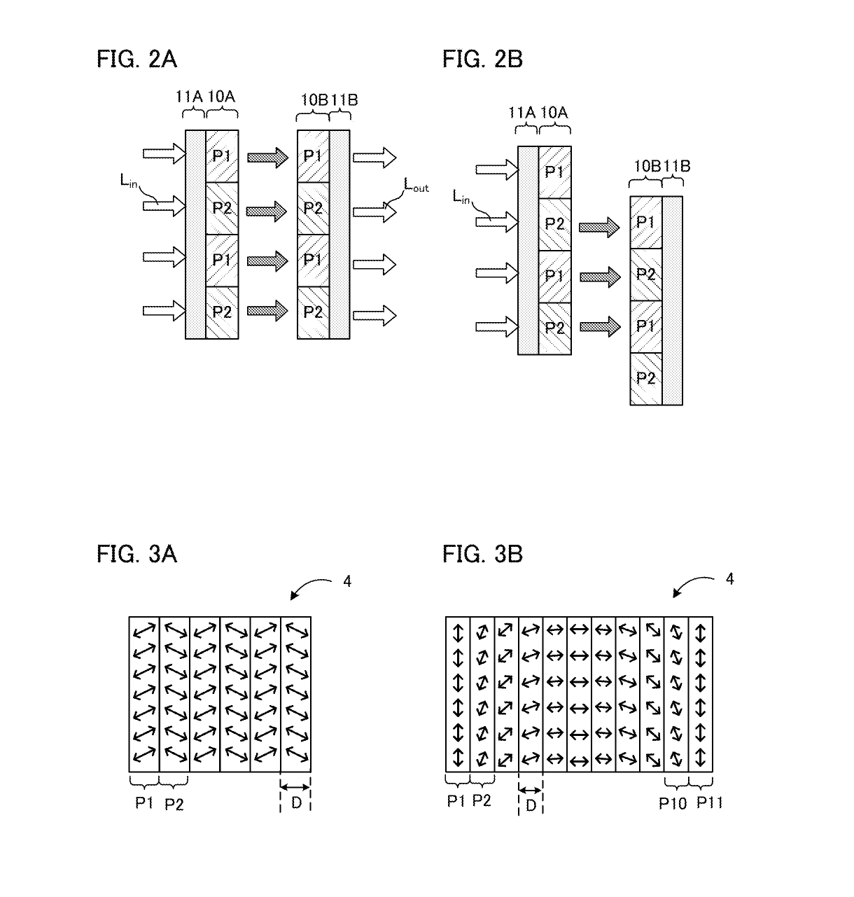

The light controlling sheet of an embodiment of the present invention is a sheet used in a light controlling plate. As illustrated in FIGS. 2A to 2B for reference, two light controlling sheets 10A and 10B are bonded to adherends 11A and 11B, such as window glass, respectively, to be allowed to face each other. By changing correspondence relationship between the pattern regions P1 and P2 in the light controlling sheet 10A and the pattern regions P1 and P2 in the light controlling sheet 10B, the transmittance of light can be changed, thereby adjusting the quantity of the transmitted light. In this way, display switching can be attained.

As illustrated in, for example, FIG. 2A, when the pattern regions P1 in the light controlling sheet 10A correspond to the pattern regions P1 in the light controlling sheet 10B, and further the pattern regions P2 in the light controlling sheet 10A correspond to the pattern regions P2 in the light controlling sheet 10B, incident light Lᵢₙ penetrate through the light controlling plate. Outgoing light Lₒᵤₜ therefrom can make the light controlling plate into a bright state. In the meantime, as illustrated in FIG. 2B, when the pattern regions P1 in the light controlling sheet 10A correspond to the pattern regions P2 in the light controlling sheet 10B, and further the pattern regions P2 in the light controlling sheet 10A correspond to the pattern regions P1 in the light controlling sheet 10B, incident light Lᵢₙ cannot penetrate through the light controlling plate. Thus, the light controlling plate can be made into a dark state.

Incidentally, for simplifying the description, in FIGS. 2A to 2B, illustration of constituents of the light controlling sheets 10A and 10B other than the pattern regions P1 and P2 is omitted.

In a light controlling sheet as described above, which is used in a light controlling plate, a weatherable agent such as an ultraviolet absorbent cannot be usually added to the light controlling layer because the light controlling layer is changed in color by incorporating the weatherable agent into the light controlling layer.

Thus, the inventors have been making investigations of: rendering an adhesive layer which is to be a bonding surface onto an adherend, such as a window glass, positioned at a light-incidence side a weatherable adhesive layer into which a weatherable agent is incorporated; and allowing this weatherable adhesive layer to absorb wavelength light that cause a deterioration of the light controlling layer previously, thereby preventing the light controlling layer from being deteriorated. At this time, the weatherable adhesive layer can be improved in weatherability since this layer itself contains the weatherable agent. It is therefore expected that the light controlling sheet becomes excellent in weatherability and endurance.

However, the inventors have gained knowledge that even such a light controlling sheet has a problem of being changed in color or deteriorated with the passage of time not to succeed in keeping a light controlling function over a long term.

For this problem, the inventors have made eager investigations to presume that the problem is caused by migration of the weatherable agent contained in the weatherable adhesive layer with the passage of time.

Specifically, the inventors have considered that the weatherable agent in the weatherable adhesive layer is diffused by the migration, thereby lowering the content of the weatherable agent in the adhesive layer, so as to photodegrade the weatherable adhesive layer itself to be yellowed, and further decrease the effect of the weatherable adhesive layer preventing the light controlling layer from being deteriorated.

The inventors have also considered that the weatherable agent in the weatherable adhesive layer penetrates into the light controlling layer by the migration to react with a material which constitutes the light controlling layer, so that the weatherable agent is changed in color.

Furthermore, the inventors have also considered about the material, which constitutes the light controlling layer, that the material may be migrated toward or into the weatherable adhesive layer. The inventors have considered that in the same manner as in this case, the material, which constitutes the light controlling layer, reacts with the weatherable agent in the weatherable adhesive layer so that the weatherable agent is changed in color.

It is presumed that the generation of these phenomena results in deteriorating the light controlling sheet as a whole in weatherability and endurance.

In order to solve the above-mentioned problems, in an embodiment of the present invention, a migration preventing layer is arranged between a weatherable adhesive layer and a light controlling layer, thereby restraining the migration of a weatherable agent contained in the weatherable adhesive layer. It therefore becomes possible to prevent the weatherable adhesive layer from being photodegraded to be yellowed, and from being lowered in adhesive strength. Moreover, light enters into the weatherable adhesive layer prior to the light controlling layer, so that the weatherable agent contained in the weatherable adhesive layer absorbs ultraviolet rays and other wavelength light which deteriorate the light controlling layer. Consequently, the light controlling layer can be restrained from being deteriorated. Furthermore, the migration of the weatherable agent is restrained by the migration preventing layer, so that change in color due to reaction between the light-controlling-layer-constituting material and the weatherable agent can be prevented.

In this way, the light controlling sheet as a whole can be improved in weatherability and endurance.

In the present specification, the phrase “in a light controlling layer, two or more regions for changing a polarization state or phase state of transmitted light are each formed into a constant shape at a constant interval” denotes that two or more regions for changing a polarization state or phase state of transmitted light are continuously formed to each have a constant width and a constant shape. In other words, the individual regions have the same width and the same shape, and are adjacent to each other to be continuously arranged. Moreover, from the aspect of this arrangement form, the wording “regions are each formed at a constant interval” denotes that the length of a line connecting the center of any adjacent two regions usually corresponds to the width of each of the regions.

Specifically, the phrase denotes that: first regions and second regions for changing a polarization state or phase state of transmitted light each has a constant width and a constant shape, and are adjacently formed, so that the first regions and the second regions are alternately arranged; three or more regions for changing a polarization state or phase state of transmitted light each has a constant width and a constant shape, and are adjacently formed, thereby each region being repeatedly and alternately arranged; or plural regions for changing a polarization state or phase state of transmitted light each has a constant width and a constant shape, and are adjacently formed, thereby being gradually changed in polarization state or phase state.

The definition of the wording “two or more regions are each formed into a constant shape at a constant interval” is applied, in the same manner, also to retardation regions of a retardation layer, alignment regions of an alignment layer, and polarizing regions of a polarizing plate being to be detailed later.

Hereinafter, a description will be made about individual moieties of the light controlling sheet of an embodiment of the present invention.

1. Weatherable Adhesive Layer

The weatherable adhesive layer in an embodiment of the present invention is a layer including a weatherable agent formed on a migration preventing layer. This weatherable adhesive layer is formed on the migration preventing layer at an opposite side to a side in which the light controlling layer is arranged.

(1) Weatherable Agent

The weatherable agent contained in the weatherable adhesive layer may be any weatherable agent as long as the agent is, for example, an agent which can absorb wavelength light which deteriorate the light controlling layer, or an agent which can capture radicals generated when a molecular chain of a resin of the weatherable adhesive layer is cut by irradiation with light. Examples of the agent include an ultraviolet absorbent and a photooxidation inhibitor. Examples of the photooxidation inhibitor include a light stabilizer and an antioxidant.

The weatherable agent contained in the weatherable adhesive layer is particularly preferably an ultraviolet absorbent. The weatherable adhesive layer and the light controlling layer are deteriorated mainly by ultraviolet rays included in incident light; thus, the use of the ultraviolet absorbent as the weatherable agent makes it possible to prevent the light controlling sheet more effectively from being deteriorated.

The ultraviolet absorbent is not particularly limited as long as the absorbent can absorb ultraviolet rays of desired wavelengths. Such an ultraviolet absorbent material is, for example, an organic ultraviolet absorbent and a reactive ultraviolet absorbent.

Examples of the organic ultraviolet absorbent include benzophenone type, benzotriazole type, salicylate type, phenylsalicylate type, cyanoacrylate, benzoate, benzoxazinone type, triazine type, hydroxyphenyltriazine type, substituted acrylonitrile type, nickel chelate type, and hindered amine types agents.

Examples of the reactive ultraviolet absorbent include agents each obtained by introducing, into the organic ultraviolet absorbent, an addition-polymerizing double bond of, e.g., a vinyl group, acryloyl group or methacryloyl group, or a group such as an alcoholic hydroxyl group, amino group, carboxyl group, epoxy group or isocyanate group; and then attaining reactive fixation of the resultant onto a resin binder. A method for the reactive fixation may be a method of radical-polymerizing a conventionally known monomer, oligomer or resin component of a reactive polymer, and the above-mentioned addition-polymerizing-double-bond including reactive ultraviolet absorbent to prepare a copolymer. Moreover, when the reactive ultraviolet absorbent has a reactive group such as a hydroxyl group, amino group, carboxyl group, epoxy group or isocyanate group, a thermoplastic resin having reactivity with the reactive group can be used together with a catalyst as needed thereby reactive fixing the reactive ultraviolet absorbent to the thermoplastic resin bia for example, heat.

The light stabilizer is, for example, a hindered amine type or nickel complex type light stabilizer. A specific example of the light stabilizer is a light stabilizer used in an adhesive layer in a member for which a high light transmittance is required, for example, an optical film. Specific examples of a commercially available product of the hindered amine type light stabilizer include Tinuvin 111FDL, Tinuvin 123, Tinuvin 144, Tinuvin 152, Tinuvin 292, and Tinuvin 5100 (each manufactured by the company BASF); and Viosorb 770, Viosorb 622, and Viosorb 765 (each manufactured by Kyodo Chemical Co., Ltd.).

The light stabilizer may be a reactive light stabilizer including, in the molecule thereof, a reactive functional group such as a (meth)acryloyl group. A specific example thereof is 1,2,2,6,6-pentamethyl-4-piperidinyl methacrylate (trade name: SANOL LS-3410, manufactured by Nippon Nyukazai Co., Ltd.).

The antioxidant may be, for example, a hindered phenol type antioxidant. Specific examples thereof include IRGANOX 1035 and IRGANOX 3114 (each manufactured by Ciba Specialty Chemicals Ltd.).

The weatherable adhesive layer may contain, as the weatherable agent, only an ultraviolet absorbent. The weatherable adhesive layer preferably contains, as the weatherable agent, a photooxidation inhibitor in addition to the ultraviolet absorbent. By using, as the weatherable agent, the ultraviolet absorbent and the photooxidation inhibitor together, the photooxidation inhibitor captures radicals generated when ultraviolet rays are radiated, so that the weatherable adhesive layer can be prevented from suffering from oxidation and bond cleavage.

Incidentally, the wording “the weatherable adhesive layer contains, as the weatherable agent, a photooxidation inhibitor in addition to the ultraviolet absorbent” denotes that this layer contains at least one of a light stabilizer and an antioxidant in addition to the ultraviolet absorbent. This layer may contain both a light stabilizer and an antioxidant.

The content of the weatherable agent (solid) in the weatherable adhesive layer is preferably within a range of about 0.1 parts by mass to 40 parts by mass, particularly preferably within a range of about 1 parts by mass to 30 parts by mass for 100 parts by mass of an adhesive that will be detailed below. If the content of the weatherable agent is larger than the range, in the case of using, for example, a benzotriazole type ultraviolet absorbent as the weatherable agent, the weatherable adhesive layer may be colored so that the light controlling sheet may have, as a whole, a defect in the external appearance. In the meantime, if the content is less than the range, the weatherable adhesive layer may not sufficiently absorb ultraviolet rays or other wavelength light which deteriorate the light controlling layer, so that the light controlling layer is not restrained from being deteriorated.

When the weatherable adhesive layer contains only an ultraviolet absorbent as the weatherable agent, the content of the ultraviolet absorbent therein is preferably within the above-mentioned range. Moreover, when the weatherable adhesive layer contains both of an ultraviolet absorbent and a photooxidation inhibitor as the weatherable agent, it is preferred that the content of the ultraviolet absorbent is within the above-mentioned range and the content of the photooxidation inhibitor is also within the above-mentioned range.

(2) Adhesive

An adhesive used to form the weatherable adhesive layer is not particularly limited as long as the weatherable adhesive layer can exhibit desired adhesive strength and have a high light transmissivity. Examples of the adhesive include acrylic type adhesives, silicone type adhesives, ester type adhesives, urethane type adhesives, fluorine-contained type adhesives, polyimide type adhesives, epoxy type adhesives, polyurethane ester type adhesives, vinyl acetate type adhesives, synthetic rubber type adhesives, and natural rubber type adhesives. Among these adhesives, acrylic type adhesives are preferred since the adhesives are excellent in transparency, endurance and heat resistance, and low in cost. Examples of the acrylic type adhesives include acrylic copolymers each obtained by copolymerizing an acrylic acid ester with other monomers.

Examples of the acrylic acid ester include ethyl acrylate, n-butyl acrylate, 2-ethylhexyl acrylate, isooctyl acrylate, isononyl acrylate, hydroxyethyl acrylate, propylene glycol acrylate, acrylamide, and glycidyl acrylate. Among these examples, ethyl acrylate, n-butyl acrylate, and 2-ethylhexyl acrylate are preferred since these esters show a good bondability onto an adherend such as a window glass. These acrylic acid esters may be used alone or in the form of a mixture of two or more thereof.

Examples of the above-mentioned other monomers include methyl acrylate, methyl methacrylate, styrene, acrylonitrile, vinyl acetate, acrylic acid, methacrylic acid, itaconic acid, hydroxyethyl acrylate, hydroxyethyl methacrylate, propylene glycol acrylate, acrylamide, mathacrylamide, glycidyl acrylate, glycidyl methacrylate, dimethylaminoethyl methacrylate, tert-butylaminoethyl methacrylate, and n-ethylhexyl methacrylate. Among these examples, n-ethylhexyl methacrylate is preferred. These other monomers may be used alone or in the form of a mixture of two or more thereof.

(3) Optional Additives

The weatherable adhesive layer may contain an infrared reflecting agent or an infrared absorbent in addition to the above-mentioned materials. When the light controlling sheet of an embodiment of the present invention is used in a light controlling plate, the transmission of light is blocked so that the light controlling plate turns into a dark state. At this time, in order to block the light completely, the black color density in the dark state needs to be heightened. It is necessary to restrain the transmission of wavelength light in a wide scope including not only the visible ray region but also an infrared region.

It is therefore preferred to add an infrared reflecting agent or an infrared absorbent into the weatherable adhesive layer so that the agent reflects or absorbs infrared rays to restrain the transmission of the infrared rays.

Examples of the infrared reflecting agent include tin oxide, tin indium oxide, metal complex dyes, and zinc oxide. Examples of the infrared absorbent include titanium oxide, zinc oxide, indium oxide, tin-doped indium oxide (ITO), tin oxide, antimony-doped tin oxide (ATO), and zinc sulfide metal oxide type infrared absorbents. These species of the infrared reflecting agent and the infrared absorbent are examples. Thus, the agent and the absorbent are not limited to these materials.

The content of the infrared reflecting agent or the infrared absorbent in the weatherable adhesive layer is preferably within a range of about 0.1 parts by mass to 20 parts by mass, more preferably within a range of about 0.5 parts by mass to 10 parts by mass, particularly preferably within a range of about 1 parts by mass to 5 parts by mass for 100 parts by mass of the acrylic copolymer. If the content of the infrared reflecting agent or the infrared absorbent is more than the range, the light controlling sheet of an embodiment of the present invention may be lowered in transparency to be lowered in light transmittance. In the meantime, if the content is less than the range, a light controlling plate including the light controlling sheet of an embodiment of the present invention may not gain a sufficient black color density to be insufficient in light blocking performance.

The weatherable adhesive layer may contain, in addition to the above-mentioned materials, for example, a crosslinking agent, a silane coupling agent, an adhesion supplier, a filler, and a leveling agent.

Examples of the crosslinking agent include isocyanate type, metal chelate type, epoxy type, and melamine type agents.

(4) Others

The thickness of the weatherable adhesive layer may be any thickness as long as the thickness permits the above-mentioned desired amount of the weatherable agent to be contained in this layer. The thickness is, for example, preferably within a range of about 5 μm to 80 μm, more preferably within a range of about 10 μm to 60 μm, particularly preferably within a range of about 15 μm to 40 μm. If the thickness of the weatherable adhesive layer is more than the range, the light controlling sheet may be lowered in light transmissivity or be raised in haze to have, for example, an external appearance defect, and may further undergo an inconvenience for the bonding. In the meantime, if the thickness is less than the range, the weatherable adhesive layer may not be able to contain the desired amount of the weatherable agent, or may not give a desired adhesive strength so that the resultant sheet may not be able to ensure a function of a light controlling sheet.

The weatherable adhesive layer has a high transparency in the visible ray region. The transmittance of the weatherable adhesive layer in the visible ray region is preferably 70% or more, more preferably 80% or more, particularly preferably 90% or more. Incidentally, the transmittance is measurable according to JIS K7361-1 (Plastics—Method for Testing Total Light Transmittance of Transparent Material).

The adhesive strength of the weatherable adhesive layer is preferably within a range of about 4 N/25 mm to 30 N/25 mm, more preferably within a range of about 4 N/25 mm to 25 N/25 mm, particularly preferably within a range of about 4 N/25 mm to 20 N/25 mm. When the adhesive strength of the weatherable adhesive layer is in the range, the light controlling sheet of an embodiment of the present invention can be stably bonded to an adherend. Furthermore, when the light controlling sheet is peeled from the adherend, the peeling can be attained without generating, for example, the remaining of the adhesive on the adherend.

Incidentally, the adhesive strength is a value obtained by measuring a 25 mm-width sample of the sheet (adherend: a blue glass plate having a thickness of 3 mm) in a 180°-peeling-off manner (peeling-off rate: 300 mm/min.) by a method according to JIS Z0237.

At this time, it is preferred that the adhesive strength of the weatherable adhesive layer is equal to or less than the adhesive strength of the adhesive layer, which will be detailed later. The adhesive layer is a layer for bonding the migration preventing layer to, for example, the light controlling layer; and if the weatherable adhesive layer is larger in adhesive strength than the adhesive layer, a material breakage may be caused between the adhesive layer and the migration preventing layer in the case of peeling off the light controlling sheet of an embodiment of the present invention bonded to an adherend, so that the adhesive of a portion of the light controlling sheet may remain on the surface of the adherend.

Incidentally, details of the adhesive strength of the adhesive layer will be described later.

2. Migration Preventing Layer

The migration preventing layer in an embodiment of the present invention is a layer formed on the adhesive layer.

The migration preventing layer is arranged between the weatherable adhesive layer and the light controlling layer, thereby having a function of preventing the migration of the weatherable agent from the weatherable adhesive layer.

Incidentally, the migration preventing layer is arranged preferably directly on a surface of the weatherable adhesive layer. That is because the migration of the weatherable agent can be prevented efficiently.

The migration preventing layer may be any layer as long as the layer is a layer having a high light transmissivity and having a layer structure from which the weatherable agent is not easily migrated. Such a migration preventing layer may be a layer comprising a transparent resin (transparent resin layer), or a layer comprising a transparent inorganic compound (transparent inorganic compound layer).

(1) Aspect Comprising Transparent Resin

About the migration preventing layer comprising a transparent resin (hereinafter, in the present section, the layer may be referred to as the layer in the present aspect), the wording “having a structure from which the weatherable agent is not easily migrated” denotes that the transparent resin in the migration preventing layer is high in crosslinkage density.

About the migration preventing layer comprising a transparent resin, the material thereof itself is inexpensive and widely usable. Moreover, the present aspect has an advantage that generally commercially available film or sheet comprising a transparent resin can be used as the migration preventing layer.

The transparent resin may be any transparent resin as long as the resin can form a migration preventing layer having a desired light transmissivity. The transparent resin may be a cured resin or a thermoplastic resin. The cured resin denotes a resin cured by heat, or irradiation with ultraviolet rays or an ionizing radiation such as an electron beam.

Specific examples of the transparent resin include polyester resins such as polyethylene terephthalate (PET) and polyethylene naphthalate (PEN); polyolefin resins such as polyethylene (PE), polypropylene (PP), and cyclic polyolefin (COP); cellulose resins such as cellulose triacetate (CTA); acrylic resins such as polymethyl methacrylate (PMMA); urethane resins, and acrylic silicone resins; fluorocarbon resins; epoxy resins; polycarbonate (PC) resins; imide resins such as polyimide (PI) and polyetherimide (PEI); polyamideimide (PAI) resins; vinyl resins; polyvinyl chloride (PVC) resins; melamine resins; aminoalkyd resins; sulfone resins such as polysulfone (PSF) and polyethersulfone (PES); urea resins; polyetherether ketones (PEEKs); acryl polyol resins; acryl/urethane copolymers; and acryl polyol/isocyanate copolymers.

Among the above, the transparent resin is preferably the polyester resins. The polyester resin is more preferably PET. A migration preventing layer in the present aspect comprising polyester resin, in particular PET, among the above-mentioned transparent resins has a high crosslinkage density so that the migration of the weatherable agent can be efficiently hindered, and further, it is inexpensive and widely usable.

The light transmittance of the transparent resin is not particularly limited as long as the migration preventing layer and the light controlling sheet can show a light transmissivity that will be detailed later. Thus, the light transmittance is not specified to any exact transmittance.

The configuration of the migration preventing layer in the present aspect may be, for example, in the form of a sheet or in the form of a film.

The migration preventing layer in the present aspect preferably has a thickness enabling the weatherable agent to be sufficiently restrained from being migrated from the weatherable adhesive layer. The thickness is, for example, preferably within a range of about 10 μm to 70 μm, more preferably within a range of about 12 μm to 50 μm, particularly preferably within a range of about 16 μm to 25 μm. If the thickness of the migration preventing layer in this aspect is larger than the range, the light controlling sheet may be lowered in light transmissivity or may be raised in haze to have an external appearance defect or other defects, and further may undergo an inconvenience for the bonding. In the meantime, if the thickness is smaller than the range, the weatherable agent may ooze out through the migration preventing layer, or the light controlling sheet may be small infirmness so that when the sheet is produced, wrinkles and others are easily generated therein to damage the external appearance of the sheet.

The method for forming the migration preventing layer in the present aspect is not particularly limited, and depends on the species of the transparent resin. Examples of the method include a method of applying a composition for the migration preventing layer which contains a transparent resin onto an adhesive layer; and a method of applying a composition for the migration preventing layer which contains a curing resin onto an adhesive layer, and then curing the resin by, for example, heat or irradiation with light to form the migration preventing layer.

Furthermore, the migration preventing layer may be produced by laminating a commercially available resin film or sheet onto an adhesive layer.

(2) Aspect Comprising Transparent Inorganic Compound

For the migration preventing layer comprising a transparent inorganic compound (hereinafter, in the present section, the layer may be referred to as the layer in the present aspect), the wording “having a structure from which the weatherable agent is not easily migrated” denotes that it is high in layer density or film density.

The migration preventing layer comprising a transparent inorganic compound is high in density even when small in thickness. Thus, the present aspect has an advantage that the migration of the weatherable agent can be efficiently hindered.

The transparent inorganic compound may be any transparent inorganic compound as long as the compound can form a migration preventing layer having a desired light transmissivity. Examples thereof include any inorganic oxide, inorganic nitride, inorganic carbide, inorganic oxycarbide, inorganic carbonitride, inorganic oxynitride and inorganic oxycarbonitride, and any mixture of two or more of these compounds.

Specific examples thereof include oxides such as silicon oxide, aluminum oxide, zinc oxide, tin oxide, cerium oxide, magnesium oxide, indium oxide, calcium oxide, zirconium oxide, titanium oxide, boron oxide, hafnium oxide and barium oxide; nitrides such as silicon nitride, aluminum nitride, boron nitride and magnesium nitride; carbides such as silicon carbide; and sulfides. Other examples thereof include tin-doped indium oxide (ITO), fluorine-doped indium oxide (FTO), and aluminum-doped zinc oxide (AZO).

The transparent inorganic compound has transparency. The light transmittance of the transparent inorganic compound may be any light transmittance as long as the light controlling sheet can show a desired light transmissivity. Thus, the light transmittance is not specified to any exact transmittance.

The configuration of the migration preventing layer in the present aspect may be, for example, a monolayered or multilayered film, or a vapor-deposited film.

The migration preventing layer in the present aspect is preferably a thin film permitting the weatherable agent to be sufficiently restrained from being migrated from the weatherable adhesive layer. The thickness is, for example, preferably within a range of about 5 nm to 1 μm, more preferably within a range of about 10 nm to 0.2 μm. If the thickness of the migration preventing layer in this aspect is larger than the range, the light controlling sheet may be lowered in light transmissivity or may be raised in haze to have an external appearance defect or other defects. In the meantime, if the thickness is smaller than the range, the weatherable agent may ooze out through the migration preventing layer, or the light controlling sheet may be small infirmness so that when the sheet is produced, wrinkles and others are easily generated therein to damage the external appearance of the sheet.

The migration preventing layer in the present aspect can be formed by vapor-depositing a transparent inorganic compound, using, for example, a sputtering method, an ion plating method or a vacuum vapor deposition method.

(3) Others

The migration preventing layer may be a single layer comprising a transparent resin or a transparent inorganic compound, or may be a laminated body in which an organic layer comprising a transparent resin layer and an inorganic layer comprising a transparent inorganic compound are laminated.

Since the migration preventing layer comprises a resin or inorganic compound having transparency, this layer shows a high transparency. The transmittance of the migration preventing layer in the visible ray region is preferably 70% or more, more preferably 80% or more, particularly preferably 90% or more. Incidentally, the transmittance is measurable in accordance with JIS K7361-1 (Plastics—Method for Testing Total Light Transmittance of Transparent Material).

3. Adhesive Layer

The adhesive layer in an embodiment of the present invention is a layer formed on the light controlling layer to bond the light controlling layer and the migration preventing layer to each other.

The material of the adhesive layer may be, for example, an adhesive. This adhesive layer may be the same as those described in the above-mentioned section “1. Weatherable Adhesive Layer”. Among the adhesives, an acrylic adhesive is preferred.

The adhesive used in the adhesive layer may be identical with or different from the adhesive used in the weatherable adhesive layer.

It is preferred that the adhesive layer does not contain any one of the weatherable agents described in the section “1. Weatherable Adhesive Layer”. Even the adhesive layer does not contain any weatherable agent, the weatherable adhesive layer previously absorbs wavelength light which cause the deterioration so that the adhesive layer can be prevented from being deteriorated.

The adhesive layer may appropriately contain an additive as required. The additive contained in this adhesive layer may be the same as those described in the section “1. Weatherable Adhesive Layer”.

The thickness of the adhesive layer is preferably a thickness enabling the migration preventing layer and the light controlling layer to be bonded to each other with a sufficient adhesive strength, and enabling the light controlling sheet of an embodiment of the present invention to have a desired light transmissivity. The thickness of the adhesive layer is, for example, preferably within a range of about 10 μm to 50 μm, more preferably within a range of about 10 μm to 40 μm, particularly preferably within a range of about 10 μm to 30 μm. If the thickness of the adhesive layer is larger than the range, the light controlling sheet of an embodiment of the present invention may be lowered in light transmissivity. In the meantime, if the thickness is smaller than the range, the migration preventing layer and the light controlling layer may not be sufficiently bonded to each other so that the light controlling sheet of an embodiment of the invention may be lowered in mechanical strength.

Incidentally, the thickness of the adhesive layer may be equivalent to or smaller than that of the weatherable adhesive layer.

The adhesive layer has a transparency. The transmittance of the adhesive layer in the visible ray region may be made equivalent to that of the weatherable adhesive layer.

The adhesive strength of the adhesive layer may be any adhesive strength that enables the light controlling layer and the migration preventing layer to be sufficiently bonded to each other so that the two layers are not peeled off easily from each other. The strength is, for example, preferably 20 N/25 mm or more. When the adhesive strength of the adhesive layer is in this range, the light controlling layer and the migration preventing layer can be sufficiently bonded to each other. Thus, the light controlling sheet can be a sheet in which a material breakage or any other inconvenience due to peeling between layers is not easily caused.

Incidentally, the method for measuring the adhesive strength is the same as described in the section “1. Weatherable Adhesive Layer”.

4. Light Controlling Layer

The light controlling layer in an embodiment of the present invention is a layer in which two or more regions for changing a polarization state or phase state of transmitted light are each formed into a constant shape at a constant interval.

The wording “regions for changing a polarization state or phase state of transmitted light” denotes regions through which only straightly polarized light of a specified vibration direction, among light entering into the light controlling layer, are transmitted; or regions for rotating a vibration direction of straightly polarized light entering into the light controlling layer in accordance with the retardation, thereby converting to right circularly polarized light or to left circularly polarized light.

The two or more region for changing a polarization state or phase state of transmitted light are each formed into a constant shape at a constant interval. In other words, the two or more regions are continuously formed to each have a constant width and a constant shape to be arranged into a continuous pattern.

Examples of the shape of the regions include a triangle, quadrangles such as a square, a rectangle and a rhombus, and hexagons. Examples of the arrangement pattern of the regions include the form of stripes, and a hound's-tooth check form. The regions are particularly preferably in the form of rectangular stripes.

Furthermore, as illustrated in FIG. 3A for example, the arrangement pattern may be an arrangement pattern in which first regions P1 and second regions P2 are alternately and continuously formed, the second regions P2 having the same shape and the same width D as the first regions P1 but changing transmitted light into a polarization state or phase state different from that of the first regions P1. At this time, the arrangement pattern of a plurality of the first regions P1 are an arrangement pattern in which the regions are formed at a constant interval D corresponding to the width D of any one of the second regions between two of the first regions P1.

Moreover, the arrangement pattern may be an arrangement pattern in which three or more region for changing transmitted light into polarization states or phase states different from each other are continuously formed to be repeatedly arranged, which is not illustrated in any figure.

Furthermore, as illustrated in FIG. 3B, the arrangement pattern may be an arrangement pattern in which plural regions P1 to P11 which have the same shape and the same width D but are different from each other in polarization state or phase state are continuously formed so that polarization state or phase state is changed in stages. At this time, the distance between the center of any one of all the regions and the center of a region adjacent to the region has the constant interval D corresponding to the width D of each of the regions.

Incidentally, in FIGS. 3A to 3B, any arrow in each of the regions P is an arrow showing the direction of a factor for changing the polarization state or phase state, for example, the direction of the polarization axis, or the in-plane slow-axis direction of the retardation region.

The widths (intervals) of the respective regions in the light controlling layer are usually equal to each other, and are not particularly limited as long as the widths enables the transmitted light to be changed in polarization state or phase state. The widths each is preferably within a range of about 0.5 cm to 5.0 cm, more preferably within a range of about 0.8 cm to 3.0 cm, particularly preferably within a range of about 1.0 cm to 1.5 cm. If the width is smaller than the range, the number of joining-portions between the regions becomes large so that a light controlling plate including the light controlling sheet of an embodiment of the present invention may be lowered in light shielding performance. In the meantime, if the width is larger than the range, in a light controlling plate including the light controlling sheet of an embodiment of the present invention, sliding width will be larger so as to induce a necessity to increase the size of a light-incidence surface of the light controlling plate. Thus, the resultant product may be deteriorated in external appearance or operability. Incidentally, when the regions are in the form of stripes, the width of each of the regions denotes the length in the short-side direction of the region. When the regions are in any other form, the width can be specified by the length between two of their centers.

The layer structure of the light controlling layer may be classified into, for example, an aspect including a pattern retardation layer, and a polarizing plate arranged nearer to the adhesive layer than the pattern retardation layer (first aspect); and an aspect that regions for changing a polarization state of light (hereinafter, the regions may be referred to as polarizing regions) are patternwise formed directly on a polarizing plate (second aspect).

Hereinafter, the aspects of the light controlling layer will each be described.

(1) First Aspect

The light controlling layer in the present aspect includes a pattern retardation layer, and a polarizing plate arranged nearer to the adhesive layer than the pattern retardation layer. The pattern retardation layer is preferably a layer including a transparent film substrate, an alignment layer formed on the transparent film substrate, and a retardation layer formed on the alignment layer, and in the retardation layer, two or more retardation regions different from each other in at least one of in-plane slow-axis direction and retardation are each formed into a constant shape at a constant interval. When the light controlling sheet of an embodiment of the present invention is used to produce a light controlling plate, such structure of the light controlling layer makes it possible to easily design the light controlling plate as a light controlling plate including a sliding mechanism, and further make the operation of the light controlling plate easy.

Incidentally, the retardation regions in the retardation layer are regions corresponding to the above-mentioned pattern regions. Moreover, in the phrase “in the retardation layer, two or more retardation regions different from each other in at least one of in-plane slow-axis direction and retardation are each formed into a constant shape at a constant interval”, the wording two or more retardation regions are each “formed into a constant shape at a constant interval” has the same meanings as the wording that two or more retardation regions are “continuously formed to have the same width and the same shape”.

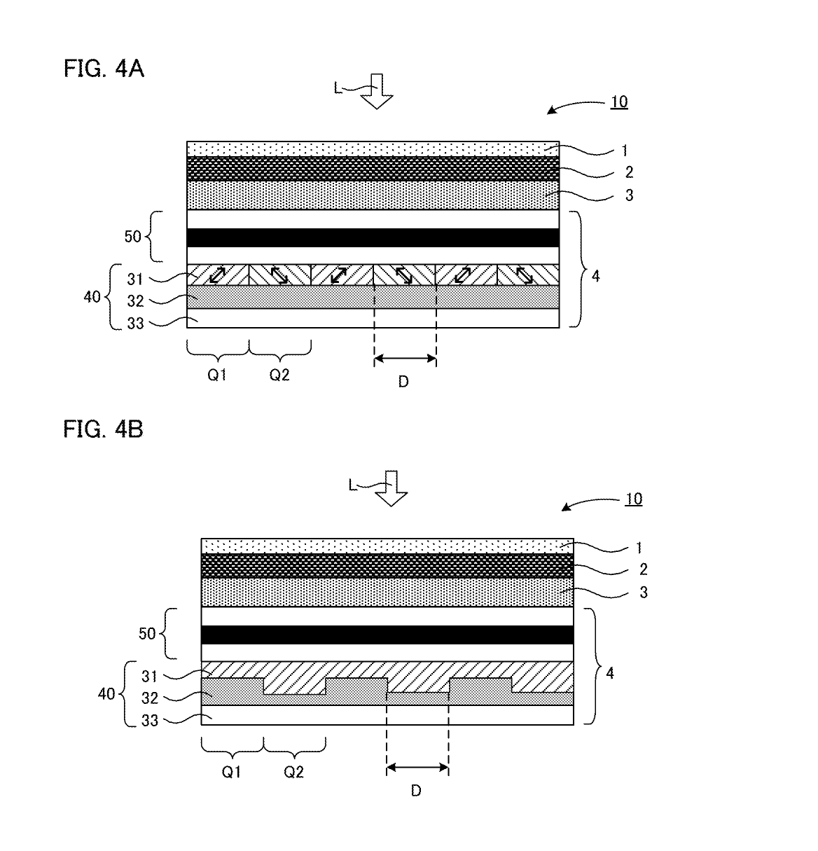

The following will describe an example of a light controlling sheet including such a light controlling layer, referring to FIGS. 4A to 4B. FIGS. 4A to 4B are each a schematic sectional views illustrating another example of the light controlling sheet. Constituents other than the light controlling layer may be the same as those described with reference to FIGS. 1A to 1B.

A light controlling layer 4 in the present aspect includes a pattern retardation layer 40, and a polarizing plate 50 arranged nearer to an adhesive layer 3 side than the pattern retardation layer 40. The pattern retardation layer 40 is a layer in which at least a transparent film substrate 33, an alignment layer 32 and a retardation layer 31 are laminated in this order. In the retardation layer 31, two or more retardation regions Q1 and Q2 different from each other in at least one of in-plane slow-axis direction and retardation are continuously formed to each have a constant width D and a constant shape (stipe shape).

Incidentally, the aspect of the retardation layer 31 shown in FIGS. 4A to 4B will be described later.

It is sufficient for the retardation layer of the pattern retardation layer to be a layer in which the respective alignments of the retardation regions are fixed so that the pattern retardation layer may be in the form of containing no alignment layer. The pattern retardation layer containing no alignment layer is obtained, for example, by forming a retardation layer separately on a temporary substrate, by regulating alignment via an alignment layer and then fixing by photocuring via irradiation with, for example, ultraviolet rays; and then, transferring the resultant retardation layer onto a transparent film substrate.

(a) Polarizing Plate

The polarizing plate in the present aspect is a polarizing plate arranged nearer to the adhesive layer side of the light controlling sheet, in the light controlling layer, than the pattern retardation layer.

The polarizing plate is not particularly limited as long as the polarizing plate is a plate capable of converting transmitted light to straightly polarized light, and may be, for example, a polarizing plate used generally in a liquid crystal display device.

This polarizing plate is not particularly limited as long as the polarizing plate includes at least a polarizer. The polarizing plate may be, for example, in a form including a polarizer and a polarizing plate protecting film arranged on at least one surface of the polarizer. The polarizing plate may be a polarizing plate obtained by stacking or fixing the polarizer onto the pattern retardation layer.

The polarizer is not particularly limited as long as the polarizer is a member capable of converting transmitted light to straightly polarized light. The polarizer usually contains iodine. A specific example of the polarizer is a polarizer obtained by impregnating a film comprising a polyvinyl alcohol with iodine, and monoaxially drawing the resultant so as to form a complex of the polyvinyl alcohol and iodine.

The direction of the polarization axis of the polarizing plate is not particularly limited, and may be appropriately selected in accordance with, for example, the alignment of the retardation regions in the pattern retardation layer, which will be detailed later.

The polarizing plate protecting film in the polarizing plate is not particularly limited as long as the film can protect the polarizer and further has a desired transparency. A transmittance in the visible ray region of the polarizing plate protecting film is preferably 80% or more, more preferably 90% or more. Incidentally, the transmittance of the polarizing plate protecting film is measurable in accordance with JIS K7361-1 (Plastics—Method for Testing Total Light Transmittance of Transparent Material).

A material which constitutes the polarizing plate protecting film is, for example, a cellulose derivative, cycloolefin resin, polymethyl methacrylate, polyvinyl alcohol, polyimide, polyarylate, polyethylene terephthalate, polysulfone, polyethersulfone, amorphous polyolefin, modified acrylic polymer, polystyrene, epoxy resin, polycarbonate, or polyester. Among them, it is preferred to use a cellulose derivative, cycloolefin resin, or acrylic resin as the resin material.

Incidentally, specific examples of the cellulose derivative, cycloolefin resin and acrylic resin as the material of the polarizing plate protecting film include, for example, materials of a polarizing plate protecting film that are described in JP 2012-198522 A. Among these examples, triacetyl cellulose (TAC), which is a cellulose derivative, is preferred. Although TAC is a derivative usable widely as a polarizing plate protecting film, TAC is easily deteriorated by ultraviolet rays; thus, the advantageous effects of an embodiment of the present invention are greatly produced by the use of the above-mentioned weatherable adhesive layer.

The polarizing plate protecting film may be subjected to surface treatment. For example, in the case of using triacetyl cellulose (TAC) which is a cellulose derivative, as a material of the polarizing plate protecting film, the protecting film can be improved in adhesiveness to a polarizer containing polyvinyl alcohol by saponifying a surface of the protecting film.

The thickness of the polarizing plate protecting film is not particularly limited as long as the thickness enables this film to have a desired light transmissivity. Usually, the thickness is preferably within a range of about 5 μm to 200 μm, more preferably within a range of about 15 μm to 150 μm, particularly preferably within a range of about 30 μm to 100 μm.

The polarizing plate protecting film is a film arranged on at least one surface of the polarizer. The polarizing plate protecting film is preferably arranged on at least an adhesive-layer-side surface of the polarizer.

When the polarizing plate protecting films are arranged on both surfaces of the polarizer, the polarizing plate protecting films on each surface of the polarizer may be the same, or may be different from each other. The polarizing plate protecting film arranged on the adhesive-layer-side surface of the polarizer preferably comprises triacetyl cellulose (TAC). This is because the effects of an embodiment of the present invention due to the use of the weatherable adhesive layer can be exerted greatly.

(b) Pattern Retardation Layer

The pattern retardation layer includes a transparent film substrate, an alignment layer formed on the transparent film substrate, and a retardation layer formed on the alignment layer.

(i) Retardation Layer

The retardation layer is formed on an alignment layer, and is a layer in which two or more retardation regions different from each other in at least one of in-plane slow-axis direction and retardation are each formed into a constant shape at a constant interval. In other words, the two or more retardation regions are each formed into a constant shape at a constant interval. Incidentally, in the retardation layer in an embodiment of the present invention, the alignment thereof is fixed in accordance with the individual retardation regions.

(Retardation Regions)

The retardation regions are regions different from each other in at least one of in-plane slow-axis direction and retardation.

The width and other factors of each of the retardation regions can be made equivalent to the width of each of the pattern regions of the above-mentioned light controlling layer.

(Case in which Retardation Regions are Different in In-Plane Slow-Axis Direction)

The wording “the retardation regions are different from each other in in-plane slow axis in the retardation layer” denotes that as illustrated in FIG. 4A, retardation regions showing the same in-plane retardation value are continuously formed to each have a constant width and a constant shape, and the in-plane slow-axis direction of one of any two adjacent retardation regions is orthogonal to that of the other. Incidentally, in FIG. 4A, an arrow direction in each retardation region Q1 or each retardation region Q2 of a retardation layer 31 shows the in-plane slow-axis direction.

When the in-plane slow-axis directions are different from each other, the respective in-plane retardation values (Re) of the retardation regions can be appropriately set in accordance with the material which constitutes the retardation layer, the pattern and/or others. The value is, for example, preferably within a range of about 100 nm to 160 nm, more preferably within a range of about 110 nm to 150 nm, particularly preferably within a range of about 120 nm to 140 nm.

Incidentally, the wording “in-plane retardation value” denotes an index showing the degree of the birefringence in the in-plane direction of any refractive index anisotropic body. This value is represented in accordance with

Re [nm]=(Nx−Ny)×d [nm]

: wherein Nx denotes a refractive index of a slow-axis direction showing a maximum refractive index in the in-plane direction, Ny denotes the refractive index of a fast-axis direction orthogonal to the slow-axis direction, and d denotes the thickness of the refractive index anisotropic body in a direction perpendicular to the in-plane direction. The in-plane retardation value (Re) is measurable, for example, by a parallel Nicol rotating method, using a device, KOBRA-WR, manufactured by a company Oji Scientific Instruments. The in-plane retardation value of any fine area is measurable, using a Mueller matrix with a tool, AxoScan, manufactured by Axometrics, Inc. In an embodiment of the present invention, the Re value means a value at a wavelength of 589 nm unless otherwise especially described.

(Case in which Retardation Regions are Different in Retardation)

The wording “retardation regions are different from each other in retardation in the retardation layer denotes that, for example, as illustrated in FIG. 4B: retardation regions showing the same in-plane slow-axis direction are continuously formed to each have a constant width and a constant shape; and the retardation regions are different from each other in thickness in accordance with these individual regions, so that a retardation value (in-plane retardation) corresponding to the film thickness difference is shown.

Incidentally, in the following description, retardation regions with a large thickness may be referred to as thick film regions; and retardation regions with a small thickness may be referred to as thin film regions. The thick film regions correspond to parts represented by Q2 in FIG. 4B; and the thin film regions correspond to parts represented by Q1 in FIG. 4B.

When the retardation regions are different from each other in retardation, the thickness difference between the thick film regions and the thin film regions may be appropriately decided in accordance with the material of the retardation layer, the pattern of the retardation regions, and/or others.

As illustrated in FIG. 3A, when the thick film regions and the thin film regions are alternately formed into the form of stripes, the film thickness difference is preferably a distance so as the difference between the in-plane retardation value of the thick film regions and the in-plane retardation value of the thin film regions corresponds to λ/2. This case makes it possible to adjust the in-plane retardation value of the thin film regions to a value corresponding to λ/4, and adjust the in-plane retardation value of the thick film regions to a value corresponding to λ/4+λ/2, so that linearly polarized light passing through the respective retardation regions can be converted to circularly polarized light having a relationship orthogonal to each other.

The thickness of the thick film regions and that of the thin film regions are each not particularly limited as long as the difference between the thick film regions and the thin film regions can be set into a predetermined range. When the thickness of the thick film regions are 3.0 μm and that of the thin film regions are 1.0 μm, for example, the difference therebetween is 2.0 μm. However, the thickness of the thick film regions may be set to 13.0 μm and that of the thin film regions may be set to 11.0 μm, so that the difference will be 2.0 μm. The thickness of the thick film regions is preferably within a range of about 1.6 μm to 20 μm, more preferably within a range of about 2.5 μm to 10 μm, particularly preferably within a range of about 1.5 μm to 5 μm. The thickness of the thin film is ranges preferably within a range of about 0.1 μm to 17 μm, more preferably within a range of about 1 μm to 7 μm, particularly preferably within a range of about 1 μm to 4 μm.

(Retardation Layer)

The material of the retardation layer is preferably a rodlike compound having refractive index anisotropy. This compound can be regularly aligned so that the retardation layer can have a desired retardation performance. This compound is preferably a liquid crystal material, which shows liquid crystal property. The liquid crystal material is large in refractive index anisotropy so that the retardation layer can easily have a desired retardation performance.

The liquid crystal material may be, for example, a material showing a liquid crystal phase such as a nematic phase or a smectic phase. It is preferred to use a liquid crystal material showing a nematic phase. The liquid crystal material showing a nematic phase is more easily aligned regularly than a liquid crystal material showing any other liquid crystal phase.

The liquid crystal material showing a nematic phase is preferably a material having spacers at both mesogen ends. The liquid crystal material having spacers at both mesogen ends is excellent in softness and high in transparency.

Furthermore, the rodlike compound is preferably a compound including a polymerizing functional group in the molecule, particularly, a compound including a polymerizing functional group that can be three-dimensionally crosslinked. Since the rodlike compound includes the polymerizing functional group, the rodlike compound is polymerized to be fixed. Thus, a retardation layer will be excellent in alignment stability and the retardation performance thereof is not easily changed with the passage of time. Incidentally, in the case of using the rodlike compound including a polymerizing functional group, the retardation layer will include the rodlike compound crosslinked due to the polymerizing functional group.

Incidentally, the wording “be three-dimensionally crosslinked” means that liquid crystal molecules are three-dimensionally polymerized with each other to be made into a network-structure state.

The polymerizing functional group is, for example, a polymerizing functional group polymerized, for example, by irradiation with ultraviolet rays or an ionizing radiation such as an electron beam, or by heating. Typical examples of the polymerizing functional group include a radical polymerizing functional group, and a cation polymerizing functional group.

The polymerizing functional group may be made equivalent to any polymerizing functional group in rodlike compound disclosed in JP 2012-137725 A.

Furthermore, the rodlike compound is particularly preferably a liquid crystal material showing liquid crystal property and including the polymerizing functional groups at its end. In this case, in the retardation layer, this rodlike compound will be in a state of being three-dimensionally polymerized network structure, so as to have alignment stability and an excellent optical-property-expressing performance.

Incidentally, even when a liquid crystal material including a polymerizing functional group at a single end thereof is used, the material can be crosslinked with other molecules to be stabilized in alignment.

Incidentally, specific examples of the rodlike compound may be compounds described in, for example, JP 2012-137725 A.

These rodlike compounds may be used alone or in the form of a mixture of two or more thereof.

The thickness of the retardation layer may be appropriately selectable in accordance with the species of the material thereof, or the aspect of the retardation regions.

(ii) Alignment Layer

The alignment layer is a layer having a function of aligning the rodlike compound contained in the retardation layer, when the alignment state of the retardation regions is fixed. In the alignment layer, on a surface thereof, two or more alignment regions are each formed into a constant shape at a constant interval. In other words, in the alignment layer, on a surface thereof, two or more alignment regions are continuously formed to each have a constant width and a constant shape. Thus, the retardation regions of the retardation layer can be arranged into the same shape and the same pattern at the same interval so as to correspond to the alignment regions.

The material of the alignment layer is not particularly limited as long as the alignment regions can be made into a desired pattern with a desired shape. This constituting material may be, for example, a cured resin cured by heat, or by irradiation with ultraviolet rays or an ionizing radiation such as an electron beam. Examples of the cured resin include ultraviolet cured resins, thermoset resins, and electron beam cured resins. Among these resins, ultraviolet cured resins are preferred. A specific example of an ultraviolet curing resin, which is a not-yet-cured ultraviolet cured resin, may be a resin obtained by, for example, adding a photopolymerization initiator and optional additives to a single substance or composition of the followings: polymerizing oligomer or monomer including an acryloyl group, such as urethane acrylate, epoxy acrylate, polyester acrylate, polyether acrylate or melamine acrylate; and polymerizing oligomers or monomers including a polymerizing vinyl group, such as acrylic acid, acrylamide, acrylonitrile or styrene.

The individual alignment regions in the alignment layer have a relationship corresponding to the individual retardation regions in the retardation layer. The width of each of the alignment regions can be made equivalent to the width of each of the retardation regions in the above-mentioned retardation layer.

The alignment regions may have fine convexoconcave shapes on a surface thereof. When the retardation regions are formed, the rodlike compound in the retardation layer disposed on the alignment layer can be aligned into a constant direction via the fine convexoconcave shapes formed on the surface of each of the alignment regions.

For example, in the retardation layer, when the in-plane slow-axis directions are desired to be changed in accordance with the individual retardation regions, by changing the longitudinal directions of the fine convexoconcave shapes in accordance with the corresponding alignment regions, the alignment direction of the rodlike compound can be changed so that the in-plane slow-axis directions can also be changed in accordance with the individual retardation regions.

Incidentally, the fine convexoconcave shapes formed on the surface of the alignment regions can be made equivalent to fine convexoconcave shapes on a surface of alignment regions which are described in, for example, JP 2012-137725 A.

The alignment regions may have shapes different in thickness from each other in accordance with these individual regions. When the alignment regions have the thicknesses different from each other in accordance with these individual regions, the retardation regions corresponding to the alignment regions also have different thicknesses. Consequently, in accordance with the individual retardation regions, these regions can be varied in retardation.

Furthermore, the alignment regions may have multi-step shapes.

The thickness of the alignment layer is not particularly limited as long as the thickness is within a range enabling the retardation layer to express a desired alignment regulating ability. The thickness is, for example, preferably within a range of about 0.01 μm to 1.0 μm.

(iii) Transparent Film Substrate

The material of the transparent film substrate is preferably a resin having a high transmissivity. Specific examples thereof include acetyl cellulose resins such as triacetyl cellulose; polyester resins such as polyethylene terephthalate and polyethylene naphthalate; olefin resins such as polyethylene and polymethylpentene; acrylic resins; polyurethane resins; and polyethersulfone, polycarbonates, polysulfones, polyethers, polyetherketones, poly(meth)acrylonitrile, cycloolefin polymers, cycloolefin copolymers, and other polymers. Among these resins, acetyl celluloses resins, resins such as cycloolefin polymers and cycloolefin copolymers, and acrylic resins are preferable since the in-plane retardation of the transparent film substrate can be made close to zero easily.

The thickness of the transparent film substrate is not particularly limited as long as the thickness does not deteriorate the light transmissivity, and enables the substrate to support desired retardation regions. Usually, the thickness is preferably within a range of about 20 μm to 188 μm, more preferably within a range of about 30 μm to 90 μm.

The transparent film substrate is preferably a substrate low in retardation. If the retardation of the transparent film substrate is large, this substrate affects the retardation of the retardation layer so that the light controlling function of the light controlling sheet of an embodiment of the present invention may be deteriorated. Specifically, the in-plane retardation value (Re value) of the transparent film substrate is preferably within a range of about 0 nm to 10 nm, more preferably within a range of about 0 nm to 5 nm, particularly preferably within a range of about 0 nm to 3 nm.

The transparent film substrate preferably has a high transparency, and the transmittance thereof in the visible ray region is preferably 80% or more, more preferably 90% or more. Incidentally, the transmittance of the transparent film substrate in the visible ray region is measurable in accordance with JIS K7361-1 (Plastics—Method for Testing Total Light Transmittance of Transparent Material).

Incidentally, when the alignment layer comprises an ultraviolet cured resin, a primer layer may be formed on the transparent film substrate to improve the adhesiveness between the transparent film substrate and the ultraviolet cured layer.

This primer layer may be any layer as long as it has adhesiveness onto both of the transparent film substrate and the alignment layer, and is transparent to visible light and transmits ultraviolet rays. The primer layer may be, for example, a layer comprising a vinyl chloride-vinyl acetate copolymer based or urethane based resin material.

(iv) Others

The pattern retardation layer is a layer including at least a transparent film substrate, alignment layer and retardation layer. As required, the pattern retardation layer may have some other constituent.

The thickness of the pattern retardation layer is not particularly limited as long as the thickness enables this layer to exhibit the above-mentioned functions, and may be appropriately set in accordance with the layer structure.

(2) Second Aspect

The light controlling layer in the present aspect is a layer in which two or more regions for changing a polarization state of transmitted light are each formed into a constant shape directly on a polarizing plate at a constant interval. In other words, the two or more regions are continuously formed to each have a constant width and a constant shape.

In the present aspect, the wording “the light controlling layer has two or more regions for changing a polarization state of transmitted light” means that this layer has two or more regions different from each other in polarization axis direction. In accordance with the polarization axis direction, this layer transmits light of one straightly polarized light component with a high transmittance while this layer can absorb light of another straightly polarized light component vibrating in a direction orthogonal to the one straightly polarized light component. Accordingly, the polarizing plate in the present aspect does not need to be used together with any pattern retardation layer.

Details of the polarizing regions may be made equivalent to the pattern regions in the above-mentioned light controlling layer.

Details of others of the polarizing plate in the present aspect are the same as detailed about the polarizing plate described in the above-mentioned section “(1) First Aspect”. Thus, description thereabout is omitted herein.

5. Optional Members

The light controlling sheet of an embodiment of the present invention may have, in addition to the above-mentioned members, optional member as required.

The following will describe examples of the optional member that are supposed for the light controlling sheet of an embodiment of the present invention.

(1) Peeling Layer

The light controlling sheet of an embodiment of the present invention preferably includes a peeling layer on the weatherable adhesive layer. When the sheet includes the peeling layer, dust and others are prevented from adhering onto the weatherable adhesive layer until the light controlling sheet is bonded to an adherend. Thus, the light controlling sheet can be prevented from being lowered in perceptivity by dirt. Moreover, when the light controlling sheet wound into a roll form is unwound, the following can be prevented: the surface of the weatherable adhesive layer is roughened to cause a failure in the unwinding.

The material of the peeling layer is not particularly limited as long as the material is an ordinarily used material. Examples thereof include acrylic and methacrylic resins such as polymethyl acrylate and polymethyl methacrylate, polyvinyl chloride resins, cellulose resins, silicone resins, chloride rubbers, casein, various surfactants, and metal oxides. These materials may be used alone or in the form of a mixture of two or more thereof.

(2) Infrared Reflecting Layer and Infrared Absorbing Layer

The light controlling sheet of an embodiment of the present invention may include an infrared reflecting layer or an infrared absorbing layer. The reason why the infrared reflecting layer or the infrared absorbing layer is provided, materials used in these layers, and others about the layers may be equivalent to the reason why the infrared reflecting agent or the infrared absorbing agent is added and examples of the materials of these agents having been described in the section “1. Weatherable Adhesive Layer”. Thus, description thereabout is omitted herein.

The position where the infrared reflecting layer or the infrared absorbing layer is arranged is not particularly limited. It is usually preferred to arrange the layer on a surface of the migration preventing layer. Incidentally, when the infrared reflecting layer or the infrared absorbing layer is provided, the weatherable adhesive layer may not contain any infrared reflecting agent or any infrared absorbing agent.

The thickness of the infrared reflecting layer or the infrared absorbing layer may be any thickness as long as the thickness does not deteriorate the light transmissivity of the light controlling sheet of an embodiment of the present invention and enables infrared reflecting function or infrared absorbing function to be exhibited. The thickness is, for example, preferably within a range of about 0.1 μm to 10 μm, more preferably within a range of about 0.1 μm to 5 μm.

(3) Other Members

The light controlling sheet of an embodiment of the present invention may include, for example, a scratch resistant layer, a self-cleaning layer, a light diffusion layer, an overcoat layer, and/or a protecting film as required.

6. Others

The thickness of the light controlling sheet of an embodiment of the present invention is not particularly limited as long as the sheet has a desired light transmissivity. The thickness is, for example, preferably within a range of about 100 μm to 800 μm, more preferably within a range of about 200 μm to 400 μm. If the thickness of the light controlling sheet is larger than the range, the light controlling sheet may undergo a warp or some other inconvenience when bonded to an adherend. In the meantime, if the thickness is smaller than the range, the light controlling sheet may undergo a wrinkle or some other inconvenience when bonded to an adherend.

The transmittance of the light controlling sheet of an embodiment of the present invention is preferably 20% or more, particularly preferably 30% or more in the visible ray region. Incidentally, the transmittance in the visible ray region is measurable in accordance with JIS K7361-1 (Plastics—Method for Testing Total Light Transmittance of Transparent Material).

It is sufficient for the light controlling sheet of an embodiment of the present invention to be in a use form that the weatherable adhesive layer is arranged nearer to a light-incidence side of the sheet (to a light source side) than the light controlling layer. The sheet is used in the state of being bonded to, for example, a window glass for building or an automobile, a partition, an interior, or furniture.

B. Light Controlling Plate

The following will describe the light controlling plate of an embodiment of the present invention. The light controlling plate of an embodiment of the invention is a light controlling plate comprising a first light controlling part including a first light controlling sheet and a second light controlling part including a second light controlling sheet, and the first light controlling part and the second light controlling part being arranged so that the first light controlling sheet and the second light controlling sheet face each other at an interval, characterized in that: the first light controlling sheet and the second light controlling sheet each comprises at least an adhesive layer and a light controlling layer formed on the adhesive layer; the light controlling layer is a layer in which two or more regions for changing a polarization state or phase state of transmitted light are each formed into a constant shape at a constant interval; at least one of the first light controlling sheet and the second light controlling sheet further comprises a migration preventing layer on the adhesive layer, at an opposite side to a side in which the light controlling layer is formed, and a weatherable adhesive layer including a weatherable agent formed on the migration preventing layer, and at least one of the first light controlling part and the second light controlling part is shiftable in a plane direction crossing the regions of the light controlling layer.

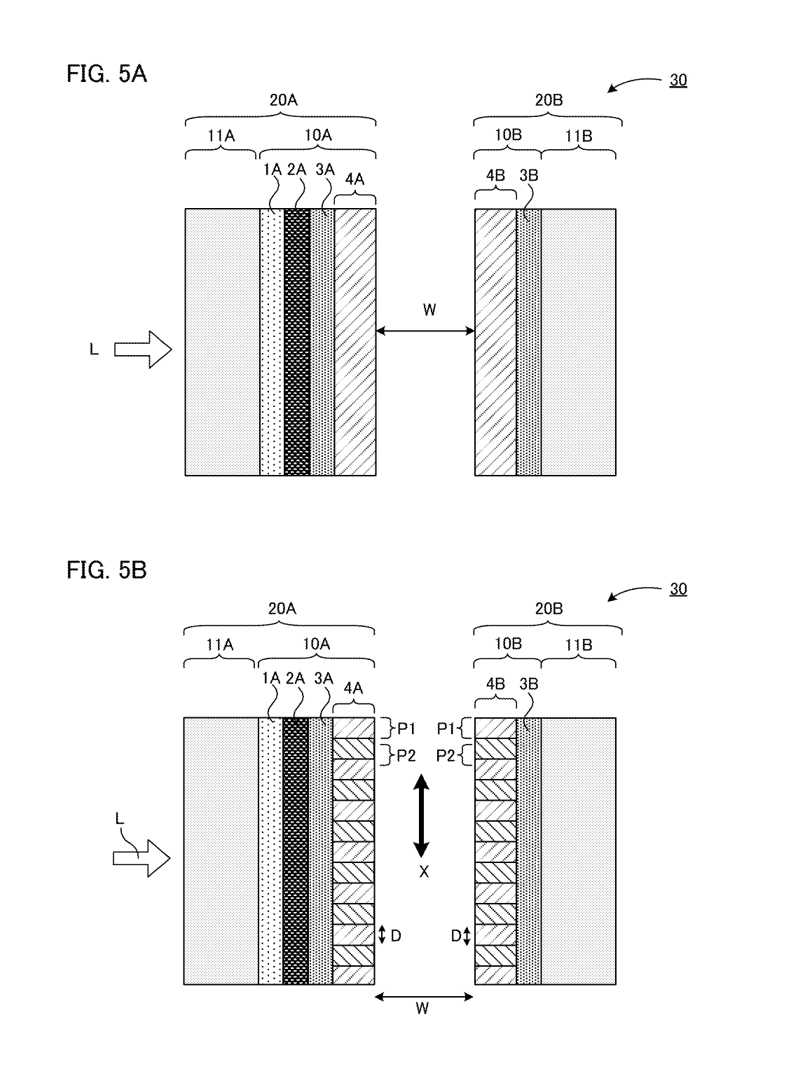

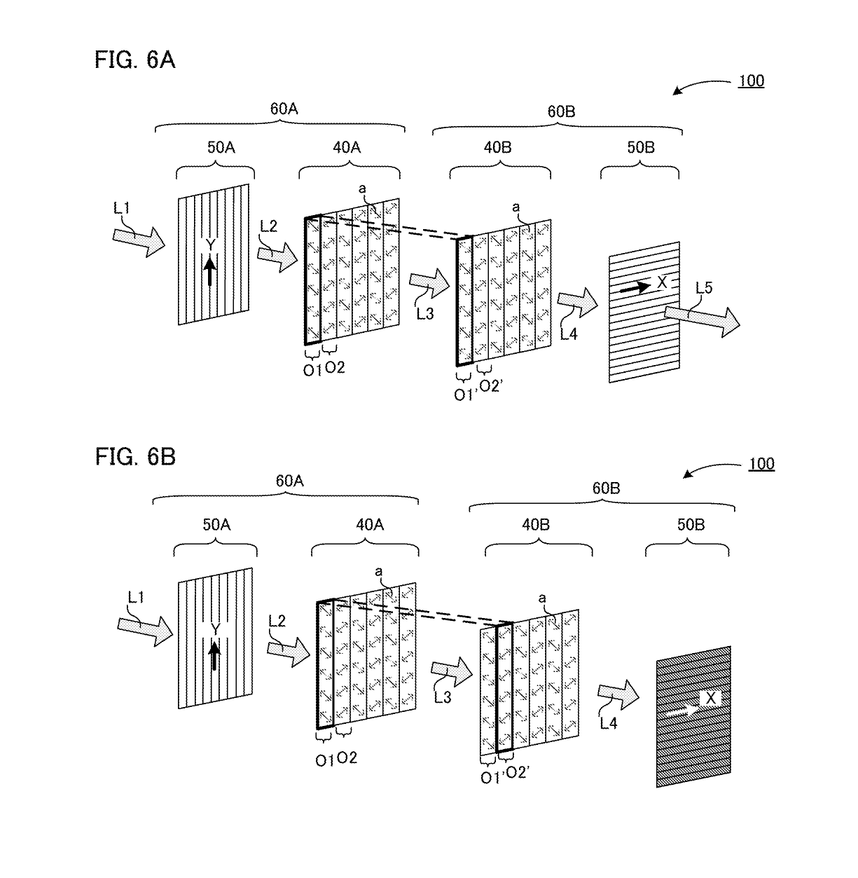

With reference to some of the drawings, the light controlling plate of an embodiment of the present invention will be described. Incidentally, FIGS. 5A to 5B are, respectively, a schematic sectional view and a top view of a light controlling plate of an embodiment of the invention. FIGS. 5A to 5B illustrate an aspect that a first light controlling part and a second light controlling part each has a light controlling sheet and a transparent substrate.

The light controlling plate 30 of an embodiment of the invention is a plate 30 in which a first light controlling part 20A including a first transparent substrate 11A and a first light controlling sheet 10A, and a second light controlling part 20B including a second transparent substrate 11B and a second light controlling sheet 10B are arranged so that the first light controlling sheet 10A and the second light controlling sheet 10B face each other at a desired interval W.

The first light controlling sheet 10A includes at least an adhesive layer 3A, and a light controlling layer 4A formed on the adhesive layer 3A, and is bonded to the first transparent substrate 11A via the adhesive layer 3A. The second light controlling sheet 10B includes at least an adhesive layer 3B, and a light controlling layer 4B formed on the adhesive layer 3B, and is bonded to the second transparent substrate 11B via the adhesive layer 3B.

The light controlling layers 4A and 4B may each be equivalent to the light controlling layer 4 described with reference to FIGS. 1A to 1B; thus, description thereabout is omitted herein.

In the example illustrated in FIGS. 5A to 5B, the first light controlling sheet 10A further includes a migration preventing layer 2A and a weatherable adhesive layer 1A between the first transparent substrate 11A and the adhesive layer 3A. Incidentally, the weatherable adhesive layer 1A is formed on the migration preventing layer 2A, at an opposite side to a side in which the light controlling layer 4A is arranged, and contains a weatherable agent. In short, the first light controlling sheet 10A is equivalent to the light controlling sheet described with reference to FIGS. 1A to 1B.

In the light controlling plate 30 of an embodiment of the present invention, at least one of the first light controlling part 20A and the second light controlling part 20B is shiftable in a plane direction (transverse direction X) crossing respective patterns of regions P1 and P2 in the form of stripes. In this way, a polarization state or phase state of transmitted light can be changed in accordance with a correspondence relationship between the pattern in the light controlling layer 4A in the first light controlling part 20A and the pattern in the light controlling layer 4B in the second light controlling part 20B. Consequently, the light controlling plate 30 can instantaneously attain switching between a bright state and a dark state.

Incidentally, in the example illustrated in FIGS. 5A to 5B, light L enters from the first light controlling part 20A side, so that the advantageous effects of an embodiment of the present invention, which will be detailed later, can be produced.

According to an embodiment of the present invention, the light controlling sheet of at least one of the first light controlling part and the second light controlling part has a layer structure in which the migration preventing layer is arranged between the weatherable adhesive layer and the light controlling layer, that is, a light controlling sheet described in the above-mentioned section “A. Light Controlling Sheet”. Thus, migration of a weatherable agent contained in the weatherable adhesive layer can be prevented, and yellowing and deterioration in adhesive strength due to photodegradation of the weatherable adhesive layer can be prevented. Moreover, among the first light controlling part and the second light controlling part, by arranging a light controlling part including a light controlling sheet described in the section “A. Light Controlling Sheet” on the light-incidence side, light will enter the weatherable adhesive layer prior to the light controlling layer, so that the weatherable agent contained in the weatherable adhesive layer absorbs ultraviolet rays and other wavelength light which deteriorate the light controlling layer. Thus, in each of the light controlling parts, the light controlling layer is restrained from being photodegraded. Furthermore, since the light controlling plate includes the migration preventing layer, a color change due to reaction between the material(s) constituting each of the light controlling layers and the weatherable agent can be prevented. In this way, the light controlling plate can be produced with high endurance and weatherability.

The light controlling plate of an embodiment of the present invention produces the above-mentioned advantageous effects by arranging a light controlling part including a light controlling sheet described in the section “A. Light Controlling Sheet” on the light-incidence side in accordance with the usage thereof.

When the light controlling plate of an embodiment of the present invention is used as a window glass, for example, for a boundary between the inside and the outside of a room, it is preferred to arrange its light controlling part including a light controlling sheet described in the section “A. Light Controlling Sheet” outdoor side. External light, such as sunlight, from the outdoors include ultraviolet rays and other rays in a large quantity; thus, by leading light into the weatherable adhesive layer prior to the light controlling layer of each of the light controlling parts, desired wavelength light can sufficiently absorbed in the weatherable adhesive layer so as to hinder the wavelength light from entering into the light controlling part.

When the light controlling plate of an embodiment of the present invention is used in an environment in which the incidence direction of light into the light controlling plate is not specified into anyone direction, for example, the plate is used as a partition indoors, each of the first light controlling part and the second light controlling part may have a light controlling sheet described in the section “A. Light Controlling Sheet”. In this case, each of the first light controlling part and second light controlling part has the weatherable adhesive layer; thus, the light controlling parts can be prevented from being deteriorated by the respective weatherable adhesive layers even when light enters into the light controlling plate from any one of the first light controlling part and second light controlling part.

Hereinafter, each of the constituents of the light controlling plate of an embodiment of the present invention will be described.

1. First Light Controlling Part and Second Light Controlling Part

The first light controlling part in an embodiment of the present invention includes at least a first light controlling sheet. The second light controlling part in an embodiment of the present invention includes at least a second light controlling sheet.

(1) First Light Controlling Sheet and Second Light Controlling Sheet

In an embodiment of the present invention, the first light controlling sheet and the second light controlling sheet each includes at least an adhesive layer and a light controlling layer formed on this adhesive layer. In the light controlling layer, two or more regions for changing a polarization state or phase state of transmitted light are each formed into a constant shape at a constant interval.

Moreover, in an embodiment of the present invention, at least one of the first light controlling sheet and the second light controlling sheet further includes a weatherable adhesive layer containing a weatherable agent, and a migration preventing layer on the adhesive layer, at an opposite side to a side in which the light controlling layer is formed. At this time, the weatherable adhesive layer is arranged on the migration preventing layer, at an opposite side to a side in which the light controlling layer is formed. Since light enters from the light-controlling-part side including the light controlling sheet of such a laminated aspect, the above-mentioned advantageous effects of an embodiment of the present invention are exhibited.

It is sufficient for at least one of the first light controlling sheet and the second light controlling sheet to include a weatherable adhesive layer and a migration preventing layer. It is preferred for each of the first light controlling sheet and the second light controlling sheet to have a weatherable adhesive layer and a migration preventing layer. In other words, each of the first light controlling sheet and the second light controlling sheet is preferably of a laminated aspect of a light controlling sheet described in the section “A. Light Controlling Sheet”.

The advantageous effects of an embodiment of the present invention are exhibited by arranging the weatherable adhesive layer on the migration preventing layer at the light controlling layer formed side, in relation to the incident light. Thus, when each of the first light controlling sheet and the second light controlling sheet includes the weatherable adhesive layer and the migration preventing layer, the advantageous effects of an embodiment of the invention can be exhibited even when either the first light controlling part or the second light controlling part is arranged at a light-incidence side.

The adhesive layer, the light controlling layer, the weatherable adhesive layer and the migration preventing layer in each of the first light controlling sheet and the second light controlling sheet may be equivalent to those described in the section “A. Light Controlling Sheet”. Thus, description thereabout is omitted herein.

Incidentally, usually, the respective light controlling layers of the first light controlling sheet and the second light controlling sheet include substantially the same pattern regions.

(2) Others

It is sufficient for the first light controlling part in an embodiment of the present invention to include at least a first light controlling sheet. However, the first light controlling sheet is preferably disposed on a surface of a first transparent substrate. In the same manner, in the second light controlling part, the second light controlling sheet is preferably disposed on a surface of a second transparent substrate. By providing each of the light controlling parts with a transparent substrate in addition to the light controlling sheet, mechanical strength of each of the light controlling parts can be improved, for example, when the light controlling plate of an embodiment of the present invention is arranged over a wide region.

Incidentally, the first transparent substrate is arranged on a surface opposite to a surface facing the second light controlling sheet, among the surfaces of the first light controlling sheet. The second transparent substrate is arranged on a surface opposite to a surface facing the first light controlling sheet, among the surfaces of the second light controlling sheet.

The first light controlling sheet alone and the second light controlling sheet alone in an embodiment of the present invention may be used as the first light controlling part and the second light controlling part, respectively, without being each bonded to an adherend such as a transparent substrate described above.

In this case, the first light controlling sheet and the second light controlling sheet each includes a protecting film, etc. on the weatherable adhesive layer.

The respective constituting materials of the first transparent substrate and the second transparent substrate are not particularly limited as long as the first light controlling sheet and the second light controlling sheet can be supported, and the materials are high in light transmissivity. Examples thereof include inorganic materials such as glass, and resin materials such as polyethylene terephthalate and other polyester resins, acrylic resin, and polycarbonate.

The first transparent substrate and the second transparent substrates preferably have a high light transmissivity. The transmittance thereof in the visible ray region is preferably 80% or more, more preferably 90% or more. Incidentally, the transmittance of each of the first transparent substrate and the second transparent substrate in the visible ray region is measurable in accordance with JIS K7361-1 (Plastics—Method for Testing Total Light Transmittance of Transparent Material).

The thickness of each of the first transparent substrate and the second transparent substrate may be any thickness as long as the thickness enables the substrate to have such a strength that the first light controlling sheet or second light controlling sheet can be held, and further enables the transparent substrate to show the above-mentioned light transmissivity. The thickness ranges, for example, preferably within a range of about 0.1 mm to 10 mm, more preferably within a range of about 1.0 mm to 5 mm.

2. Others

In the light controlling plate of an embodiment of the present invention, at least one of the first light controlling part and the second light controlling part is shifted in a plane direction crossing the pattern regions of the light controlling layer to allow the pattern regions in the first light controlling part to correspond to the pattern regions in the second light controlling part; in this way, the light controlling plate can be changed from a bright state to a dark state, or changed reversely thereto. The wording “allow the pattern regions in the first light controlling part to correspond to the pattern regions in the second light controlling part” denotes that the pattern of the regions in the first light controlling part and the pattern of the regions in the second light controlling part lap over and coincide with each other when viewed in plan.

Furthermore, aspects of an intermediate state, generated when the bright state is changed to the dark state or a change reverse thereto is made, can be changed in accordance with the pattern of each of the light controlling layers. For example, when each light controlling layer of the first light controlling part and the second light controlling part includes stripe-form pattern regions as illustrated in FIG. 3A, the light controlling plate of an embodiment of the present invention shows such an intermediate state that bright states and dark states are present in the form of stripes. In the meantime, when each light controlling layer of the first light controlling part and the second light controlling part includes stripe-form pattern regions as illustrated in FIG. 3B, the light controlling plate of an embodiment of the present invention shows such an intermediate state that the light shielding density changes step by step.

Furthermore, a pattern or design, a picture, or characters may be displayed, for example, in accordance with the correspondence relationship between the respective pattern regions in the light controlling layers.

Incidentally, the wording “the light controlling part is shifted in a plane direction crossing the regions” denotes that this part is shifted in a direction which crosses the pattern direction of the regions and which is parallel with the light controlling layer surface where the regions are formed. In other words, the part is shifted in a plane direction so as to change the relative position between the pattern regions of the first light controlling part and the pattern regions of the second light controlling part. When the pattern regions are, for example, in the form of stripes, the plane direction denotes a direction (X direction in FIGS. 5A to 5B) which crosses the longitudinal direction of the stripes and is parallel with the light controlling layer surface where the pattern regions are formed.

In the light controlling plate of an embodiment of the present invention, the interval between the first light controlling sheet and the second light controlling sheet is not particularly limited as long as the interval enables at least one of the first light controlling part and the second light controlling part to be shifted in a desired direction, and enables the sheets to exhibit a light controlling function. The interval is, for example, preferably within a range of about 0.01 mm to 5.0 mm, more preferably within a range of about 0.01 mm to 3.0 mm, particularly preferably within a range of about 0.01 mm to 0.5 mm. If the interval between the first light controlling sheet and the second light controlling sheet is larger than the range, alignment may be disturbed when light is transmitted through the light controlling plate of an embodiment of the present invention. In the meantime, if the interval is smaller than the range, the first light controlling sheet and the second light controlling sheet may contact each other to be worn away.

The light controlling plate of an embodiment of the present invention may include optional member as required. Examples of the optional member include an anti-scattering film, a diffusion film, an obscured glass, an antireflective film, an antifouling layer, a package, and a sliding mechanism.

The light controlling plate of an embodiment of the present invention is usable for, e.g., a window for building, lighting windows such as a ceiling window and a terrace, a roof and a side window of a greenhouse, a partition, an interior, furniture, and a sunroof of an automobile.

Embodiments of the present invention are not limited to the above-mentioned embodiments. The embodiments are merely examples. Thus, any embodiment that has substantially the same configurations and produces the same effects and advantageous as the technical idea recited in the claims of the disclosure are included in the technical scope of the disclosure.

### EXAMPLES

Hereinafter, the present disclosure will be described in more detail with examples and comparative examples.

### Example 1

A light controlling sheet was obtained by the following method.

(Formation of Light Controlling Layer)

A light controlling layer was obtained by the following method.

A copper plate having a size of 10 cm×10 cm was prepared, polished in right and left directions with a polisher (KANEYON (transliterated)™, manufactured by a company Kaneyo-Soap), and then washed. Thereafter, the plate was subjected to machining, up and down, with a diamond bite having convexoconcave at a pitch of 200 nm produced by FIB working, to give stripes at intervals of 0.5 inch. Thereafter, a UV curing resin (UNIDIC, manufactured by DIC Corp.) was applied onto the copper plate, and a TAC film (triacetyl cellulose; FUJITACK, manufactured by Fuji Film Co., Ltd.) as a transparent film substrate was placed and closely contacted thereto. The resultant was irradiated with ultraviolet rays to be cured.

Next, the TAC film substrate was peeled off from the copper plate, thereby giving the convexoconcave shape onto the TAC film substrate. In this way, an alignment layer was formed on the TAC film substrate. The cross sectional shape of the alignment layer was observed via SEM. As a result, alternately formed convexoconcave at a pitch of 200 nm and fine convexoconcave in an indeterminate form were observed.

Next, a solution obtained by adding 5% by weight of a photopolymerization initiator (IRGACURE 184, manufactured by the company BASF) to a solution obtained by dissolving a liquid crystal material (Licrivue (registered trade name) RMS 03-013C (trade name), manufactured by the company Merck) into a solvent cyclohexanone was applied, using a spin coater, onto a TAC film substrate including an alignment layer formed thereon. The resultant was dried at 80° C. for 10 minutes, and irradiated with ultraviolet rays to be cured. In this way, a patterned retardation film (pattern retardation layer) was produced. The produced pattern retardation layer was bonded onto a polarizing plate (HLC2-5618S) manufactured by a company Sanritsu to yield a light controlling layer.

Incidentally, in this case, the polisher was used for the rubbing. However, a cloth for rubbing that is used to produce LCDs may be used.

(Formation of Adhesive Layer)

To 100 parts by mass of an acrylic copolymer (acrylic adhesive having a solid content of 30%; product name: SK Dyne 1429DT, manufactured by Soken Chemical & Engineering Co., Ltd.), 10 parts by mass of an aluminum chelate crosslinking agent (3 parts by mass of a solid therein) (product name: AD-5A, manufactured by Soken Chemical & Engineering Co., Ltd.) was added. A scriber was used to stir the resultant at 50 rpm for 10 minutes to yield an adhesive-layer-forming coating solution. Thereafter, an applicator was used to apply the adhesive-layer-forming coating solution onto one of the surfaces of the light controlling layer to give a thickness of 83 μm before being dried. The applied solution was dried at 80° C. for 2 minutes to form an adhesive layer having a thickness of 25 μm after the drying.

The adhesive strength of the adhesive layer was 25 N/25 mm. Incidentally, the adhesive strength was measured by the measuring method described in the section “1. Weatherable Adhesive Layer”. The same measuring method was used also in examples and comparative examples that will be described hereinafter.

(Formation of Migration Preventing Layer)

A PET film (product name: COSMOSHINE A4300, manufactured by Toyobo Co., Ltd.; thickness: 16 μm) was laminated as a migration preventing layer onto the adhesive layer.

(Formation of Weatherable Adhesive Layer)

A scriber was used to stir and dissolve, at 50 rpm for 30 minutes, 100 parts by mass of an acrylic copolymer (acrylic adhesive; product name: OC3447, manufactured by Saiden Chemical Industry Co., Ltd.; solid content: 30%), and 4 parts by mass (1.18 parts by mass of a solid therein) of a benzotriazole type ultraviolet absorbent A (product name: Bio Soap 520, manufactured by Kyodo Chemical Co., Ltd.). Furthermore, 0.15 part by mass (0.15 part by mass of a solid therein) of an isocyanate XDI type (adduct body) curing agent (product name: K-341, manufactured by Saiden Chemical Industry Co., Ltd.; solid content: 75%) was added and was stirred for 10 minutes to yield a weatherable-adhesive-layer-forming coating solution A.

Next, an applicator was used to apply the weatherable-adhesive-layer-forming coating solution A onto a surface of the migration preventing layer to give a thickness of 83 μm before being dried. The applied solution was dried at 80° C. for 2 minutes to form a weatherable adhesive layer having a thickness of 25 μm after the drying. The adhesive strength of the weatherable adhesive layer was 10 N/25 mm. Incidentally, the adhesive strength was measured by the measuring method described in the section “1. Weatherable Adhesive Layer”.

Thereafter, a lightly-peeling separator film (product name: P381031, manufactured by Lintec Corp.; thickness: 38 μm), having a small silicone transferring performance, was laminated onto the weatherable adhesive layer, and the resultant was aged at 40° C. for 5 days to yield a light controlling sheet.

### Example 2

A light controlling sheet was yielded in the same way as in Example 1 except that a migration preventing layer was formed on the adhesive layer by the following method.

(Formation of Migration Preventing Layer)

An adhesive-layer-attached light controlling layer was set to a cooling drum part in a vacuum vapor-depositing machine, and the internal pressure in the machine was reduced to 10⁻⁴ Torr or less. A metal aluminum having a purity of 99.99% was loaded into an alumina crucible, and the metal aluminum was heated from the bottom of the cooling drum and evaporated. While oxygen was supplied to the machine to conduct an oxidization reaction, aluminum oxide was deposited onto the adhesive layer to form a migration preventing layer of an aluminum oxide film having a thickness of 10 nm.

### Comparative Example 1

A light controlling sheet was yielded in the same way as in Example 1 except that the migration preventing layer and the adhesive layer were not provided, and the weatherable-adhesive-layer-forming coating solution A of the above-mentioned composition was used to form a weatherable adhesive layer directly on one of the surfaces of the light controlling layer. The adhesive strength of the weatherable adhesive layer was 10 N/25 mm.

### Comparative Example 2

A light controlling sheet was yielded in the same way as in Example 1 except that the migration preventing layer and the adhesive layer were not provided, and a weatherable-adhesive-layer-forming coating solution B having a composition described below was used to form a weatherable adhesive layer directly on one of the surfaces of the light controlling layer.

Incidentally, the adhesive strength of the weatherable adhesive layer was 25 N/25 mm.

<Weatherable-Adhesive-Layer-Forming Coating Solution B>

Acrylic copolymer (acrylic adhesive; product name: SK Dyne 2094, manufactured by Soken Chemical & Engineering Co., Ltd.; solid content: 30%): 100 parts by mass; and

Benzotriazole type ultraviolet absorbent B (product name: Bio Soap 520, manufactured by Kyodo Chemical Co., Ltd.): 4 parts by mass (1.18 parts by mass of a solid therein).

### [Evaluations]

(Ultraviolet-Deterioration Resistant Test)

The light controlling sheet of each of the examples and the comparative examples was bonded to a glass piece (manufactured by Tokyo Tokushu Glass Co., Ltd.) of 100 mm length, 100 mm width and 2.8 mm thickness to produce a test piece. The test piece was subjected to an ultraviolet-deterioration resistant test through steps described below. After deteriorated, the test piece was evaluated about the external appearance and the holding power thereof.

In the ultraviolet-deterioration resistant test, a super-accelerating ultraviolet-deterioration resistant testing machine (trade name: EYE SUPER UV Tester, manufactured by Iwasaki Electric Co., Ltd.; model number: SUV-W23) was used, and a cycle of the following (A), (B) and (C) was repeated for 42 times:

(A) Under an atmosphere of a temperature of 63° C. and a humidity RH of 50%, ultraviolet rays of an illuminance of 60 mW/cm² and a peak wavelength of 365 nm were radiated onto the test piece from the glass piece side thereof for 20 hours.

(B) The test piece was subjected to water sprinkling treatment through a shower for 30 seconds.

(C) The test piece was kept under an atmosphere of a temperature of 63° C. and a humidity RH of 98% for 4 hours without being irradiated with any ultraviolet ray.

<External Appearance Evaluation>

Each of the test pieces after the ultraviolet-deterioration resistant tests was subjected to a color difference measurement. For the measurement, a spectrometer (model number: UV-3100PC, manufactured by Shimadzu Corp.) was used. In accordance with JIS K7105, the ΔE*ab value of the test piece was measured by a transmission method. Incidentally, the ΔE*ab value is a value obtained from a color difference formula of (ΔE*ab={(ΔL*)²+(Δa*)²+(Δb*)²}^{1/2}) in accordance with a (L*, a*, b*) color space system of the CIE 1976 standard. When the ΔE*ab value of the test piece was less than 2.5, the piece was judged to be good (circular mark); when the value was 2.5 or more and less than 3.0, the piece was judged to be fair (triangular mark); or when the value was 3.0 or more, the piece was judged to be bad (cross mark). For the test pieces having the ΔE*ab value of 3 or more, yellowing causing a practical problem was perceived.

<Holding Power Evaluation>

About each of the test pieces after the respective ultraviolet-deterioration resistant tests, a machine Tensilon (product name: RTG-1205, manufactured by A & D Co., Ltd.) was used to measure the holding power thereof in accordance with JIS A5759, using a head whose maximum load capacity was 0.5 kN. When the holding power was 4 N or more, the piece was judged to be good (circular mark); or when the holding power was less than 4 N, the piece was judged to be bad (cross mark). For the test pieces having holding power of less than 4 N, light peeling was caused by the ultraviolet-deterioration resistant test.

The results of the external appearance evaluation and the holding power evaluation of the light controlling sheet of each of the examples and the comparative examples are shown in Table 1.

TABLE 1

| | Weatherable | | External | | Holding |
|---|---|---|---|---|---|
| | Adhesive | Migration | Appearance | | Power |
| | Layer | Preventing | [symbol] E*ab | Eval- | Eval- |
| | Composition | Layer | Value | uation | uation |
| Exam- | A | With (PET) | 2.4 | ∘ | ∘ |
| ple 1 | | | | | |
| Exam- | A | With | 2.4 | ∘ | ∘ |
| ple 2 | | (Aluminum Oxide) | | | |
| Comp. | A | Without | 2.9 | Δ | ∘ |
| Ex. 1 | | | | | |
| Comp. | B | Without | 5 | x | x |
| Ex. 2 | | | | | |

Even though the test pieces include the weatherable adhesive layer of the same composition, Examples 1 and 2 including the migration preventing layer are lower in ΔE*ab value after the ultraviolet-deterioration resistant test than Comparative Example 1. Thus, the results shown in Table 1 suggest deterioration preventing effect of the light controlling sheet by the migration preventing layer.

In Examples 1 and 2, their external appearance and holding power are good even after the ultraviolet-deterioration resistant test. By contrast, for Comparative Example 2, whose weatherable adhesive layer composition is different from the others and has no migration preventing layer, yellowing as well as deterioration in the holding power was verified after the test. Further, Comparative Example 2 was verified to be further deteriorated than Comparative Example 1.

These results have demonstrated that by interposing a migration preventing layer between a weatherable adhesive layer and a light controlling layer, a light controlling sheet with excellent weatherability and endurance can be obtained.

### REFERENCE SIGNS LIST

1, 1A: weatherable adhesive layer

2, 2A: migration preventing layer

3, 3A, 3B: adhesive layer

4, 4A, 4B: light controlling layer

10: light controlling sheet

10A: first light controlling sheet

10B: second light controlling sheet

20A: first light controlling part

20B: second light controlling part

30: light controlling plate

40: pattern retardation layer

50: polarizing plate

1. A light controlling sheet, comprising a light controlling layer in which two or more regions for changing a polarization state or phase state of transmitted light are each formed into a constant shape at a constant interval,
an adhesive layer formed on the light controlling layer,
a migration preventing layer formed on the adhesive layer, and
a weatherable adhesive layer including a weatherable agent formed on the migration preventing layer.

2. The light controlling sheet according to claim 1, wherein the migration preventing layer comprises a transparent resin.

3. The light controlling sheet according to claim 1, wherein the migration preventing layer comprises a transparent inorganic compound.

4. The light controlling sheet according to claim 2, wherein the transparent resin is a polyester resin.

5. The light controlling sheet according to claim 4, wherein the polyester resin is polyethylene terephthalate.

6. The light controlling sheet according to claim 2, wherein the weatherable agent is an ultraviolet absorbent.

7. The light controlling sheet according to claim 3, wherein the weatherable agent is an ultraviolet absorbent.

8. The light controlling sheet according to claim 1, wherein the light controlling layer comprises a pattern retardation layer, and a polarizing plate arranged nearer to the adhesive layer than to the pattern retardation layer,
the pattern retardation layer comprises a transparent film substrate, an alignment layer formed on the transparent film substrate, and a retardation layer formed on the alignment layer, and
the retardation layer is a layer in which two or more retardation regions different from each other in at least one of in-plane slow-axis direction and retardation are each formed into a constant shape at a constant interval.

9. The light controlling sheet according to claim 1, wherein an adhesive strength of the weatherable adhesive layer is equal to or less than an adhesive strength of the adhesive layer.

10. A light controlling plate, comprising a first light controlling part including a first light controlling sheet and a second light controlling part including a second light controlling sheet, and the first light controlling part and the second light controlling part being arranged so that the first light controlling sheet and the second light controlling sheet face each other at an interval,
wherein the first light controlling sheet and the second light controlling sheet each comprises at least an adhesive layer and a light controlling layer formed on the adhesive layer,
the light controlling layer is a layer in which two or more regions for changing a polarization state or phase state of transmitted light are each formed into a constant shape at a constant interval,
at least one of the first light controlling sheet and the second light controlling sheet further comprises a migration preventing layer on the adhesive layer, at an opposite side to a side in which the light controlling layer is formed, and a weatherable adhesive layer including a weatherable agent formed on the migration preventing layer, and
at least one of the first light controlling part and the second light controlling part is shiftable in a plane direction crossing the regions of the light controlling layer.

11. The light controlling plate according to claim 10, wherein the migration preventing layer comprises a transparent resin.

12. The light controlling plate according to claim 10, wherein the migration preventing layer comprises a transparent inorganic compound.

13. The light controlling plate according to claim 11, wherein the transparent resin is a polyester resin.

14. The light controlling plate according to claim 13, wherein the polyester resin is polyethylene terephthalate.

15. The light controlling plate according to claim 11, wherein the weatherable agent is an ultraviolet absorbent.

16. The light controlling plate according to claim 12, wherein the weatherable agent is an ultraviolet absorbent.

17. The light controlling plate according to claim 10, wherein the light controlling layer comprises a pattern retardation layer, and a polarizing plate arranged nearer to the adhesive layer than to the pattern retardation layer,
the pattern retardation layer comprises a transparent film substrate, an alignment layer formed on the transparent film substrate, and a retardation layer formed on the alignment layer, and
the retardation layer is a layer in which two or more retardation regions different from each other in at least one of in-plane slow-axis direction and retardation are each formed into a constant shape at a constant interval.

18. The light controlling plate according to claim 10, wherein the first light controlling part is a part in which the first light controlling sheet is disposed on a surface of a first transparent substrate, and
the second light controlling part is a part in which the second light controlling sheet is disposed on a surface of a second transparent substrate.

19. The light controlling plate according to claim 10, wherein an adhesive strength of the weatherable adhesive layer is equal to or less than an adhesive strength of the adhesive layer.
